(19) United States
(12) Patent Application Publication
(10) Pub. No.: US 2009/0075605 A1
(43) Pub. Date: Mar. 19, 2009

(54) COMMUNICATION APPARATUS AND NETWORK INFORMATION COLLECTING PROGRAM

(75) Inventors: Eitatsu YOSHIDA, Fukuoka (JP); Wataru Nakamura, Fukuoka (JP); Wataru Nakashima, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/206,323

(22) Filed: Sep. 8, 2008

(30) Foreign Application Priority Data
Sep. 13, 2007 (JP) 2007-238327

(51) Int. Cl. H04B 1/02

(52) U.S. Cl. 455/91

(57) ABSTRACT

A network has communication apparatuses communicatively interconnected in compliance with a maintenance protocol. An LBM frame transmission unit transmits an LBM frame to the network. An MEP information acquisition unit identifies a communication apparatus having transmitted an LBR frame as an MEP when the LBR frame is received, and acquires MEP information from the LBR frame. An LTM frame transmission unit transmits an LTM frame to the MEP identified by the MEP information acquisition unit. An MIP information acquisition unit identifies a communication apparatus as an MIP from an LTR frame when the LTR frame is received as a response to the LTM frame, and acquires MIP information indicating information about the MIP. A topology information generation unit generates topology information representing a configuration of the network from the MEP information acquired by the MEP information acquisition unit and the MIP information acquired by the MIP information acquisition unit.

### CROSS-REFERENCE TO RELATED APPLICATIONS

This application is related to and claims priority to Japanese patent application no. 2007-238327, filed on Sep. 13, 2007 in the Japan Patent Office, the entire disclosure of which is incorporated by reference herein.

### BACKGROUND OF THE INVENTION

1. Field

The present invention relates to a communication apparatus that forms a network by being communicatively interconnected to a plurality of communication apparatuses in compliance with a maintenance protocol, and to a network information collecting program.

2. Description of the Related Art

Japanese Patent Laid-Open No. 9-200207 discloses a technique in which configuration information including node deletion and addition is received periodically from each network, and in which a network configuration is recognized and a configuration diagram is generated based on the received configuration information.

Japanese Patent Laid-Open No. 9-200207 does not allow acquiring configuration information and network information for performing various tests by using a special maintenance protocol like Ethernet-OAM. Specifically, the technique disclosed in Japanese Patent Laid-Open No. 9-200207 does not take Ethernet-OAM into account. Japanese Patent Laid-Open No. 9-200207 allows knowing what kinds of nodes are connected to a plurality of networks, but does not allow knowing which apparatuses are MEPs or MIPs used for Ethernet-OAM.

### SUMMARY

According to an aspect of an embodiment, a network has communication apparatuses. A communication apparatus is communicatively interconnected to a plurality of communication apparatuses in compliance with a maintenance protocol. The communication apparatus has the following functions. An LBM frame transmission unit transmits an LBM frame to the network by using a multicast LB function of the maintenance protocol. An MEP information acquisition unit identifies a communication apparatus having transmitted an LBR frame as an MEP when the LBR frame is received as a response to the LBM frame transmitted by the LBM frame transmission unit, and acquires MEP information indicating information about the MEP from the LBR frame. An LTM frame transmission unit transmits an LTM frame using a multicast LT function of the maintenance protocol to the MEP identified by the MEP information acquisition unit. An MIP information acquisition unit identifies a communication apparatus as an MIP from an LTR frame when the LTR frame is received as a response to the LTM frame transmitted by the LTM frame transmission unit, and acquires MIP information indicating information about the MIP. A topology information generation unit generates topology information representing a configuration of the network from the MEP information acquired by the MEP information acquisition unit and the MIP information acquired by the MIP information acquisition unit.

The above-described embodiments of the present invention are intended as examples, and all embodiments of the present invention are not limited to including the features described above.

### BRIEF DESCRIPTION OF THE DRAWINGS

FIG. 1 is a diagram showing a network system including communication apparatuses according to a first embodiment;

FIG. 2 is a block diagram showing a communication apparatus A according to the first embodiment;

FIG. 3 is a diagram showing exemplary information stored in a topology detection result DB;

FIG. 4 is a diagram showing exemplary topology information stored in the topology detection result DB;

FIG. 5 is a diagram showing an exemplary CCM frame;

FIG. 6 is a diagram showing an exemplary LBM frame;

FIG. 7 is a diagram showing an exemplary LBR frame;

FIG. 8 is a diagram showing an exemplary LTM frame;

FIG. 9 is a diagram showing an exemplary LTR frame;

FIG. 10 is a flowchart showing a flow of network topology detection processing in the communication apparatus A according to the first embodiment;

FIG. 11 is a diagram showing exemplary topology information recognizable based on MEP information;

FIG. 12 is a diagram showing exemplary topology information recognizable based on MIP information;

FIG. 13 is a diagram showing exemplary topology information recognizable based on detected information;

FIG. 14 is a diagram of a network in a first example collected in a second embodiment;

FIG. 15 is a diagram showing exemplary information that may be acquired after performing the LB function in the first example in the second embodiment;

FIG. 16 is a diagram showing exemplary information that may be acquired after performing the LT function in the first example in the second embodiment;

FIG. 17 is a diagram for illustrating transmission of CCM frames;

FIG. 18 is a diagram showing exemplary information that may be acquired after performing the CC function in the first example in the second embodiment;

FIG. 19 is a diagram of a network in a second example collected in the second embodiment;

FIG. 20 is a diagram showing exemplary information that may be acquired after performing the LB function in the second example in the second embodiment;

FIG. 21 is a diagram showing exemplary information that may be acquired after performing the LT function in the second example in the second embodiment;

FIG. 22 is a diagram for illustrating transmission of CCM frames;

FIG. 23 is a diagram showing exemplary information that may be acquired after performing the CC function in the second example in the second embodiment;

FIG. 24 is a diagram of a network in a third example collected in the second embodiment;

FIG. 25 is a diagram showing exemplary information that may be acquired after performing the LB function in the third example in the second embodiment;

FIG. 26 is a diagram showing exemplary information that may be acquired after performing the LT function in the third example in the second embodiment;

FIG. 27 is a diagram for illustrating transmission of CCM frames;

FIG. 28 is a diagram showing exemplary information that may be acquired after performing the CC function in the third example in the second embodiment;

FIG. 29 is a diagram of a network in a fourth example collected in the second embodiment;

FIG. 30 is a diagram showing exemplary information that may be acquired after performing the LB function in the fourth example in the second embodiment;

FIG. 31 is a diagram showing LTM response results for an MEP1 in the fourth example in the second embodiment;

FIG. 32 is a diagram showing an LTM response result for an MEP2 in the fourth example in the second embodiment;

FIG. 33 is a diagram showing exemplary information that may be acquired after performing the LT function in the fourth example in the second embodiment;

FIG. 34 is a diagram for illustrating transmission of CCM frames;

FIG. 35 is a diagram showing exemplary information that may be acquired after performing the CC function in the fourth example in the second embodiment;

FIG. 36 is a diagram showing an exemplary computer system that executes a network information collecting program;

FIG. 37 is a diagram showing an Ethernet-OAM-compliant network to which embodiments are applied;

FIG. 38 is a diagram showing MEG Levels of Ethernet-OAM;

FIG. 39 is a diagram showing a monitored MEP table setting screen for a CC function;

FIG. 40 is a diagram showing a monitored MEP/MIP table setting screen for LB/LT functions;

FIG. 41 is a diagram showing an own MEP setting screen;

FIG. 42 is a diagram for illustrating a test using the CC function;

FIG. 43 is a diagram for illustrating a test using the LB function; and

FIG. 44 is a diagram for illustrating a test using the LT function.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

A LAN (Local Area Network) is constructed with Ethernet (registered trademark). Recently, Ethernet is also used when a telecommunications carrier constructs a wide-area network such as a WAN (Wide Area Network). For example, a wide-area Ethernet using the Layer 2 of Ethernet is mainly used for an L2VPN (Layer 2 Virtual Private Network) of P2P (Point-to-Point) connection or multipoint connection.

Telecommunications carriers providing such wide-area networks perform maintenance by using SNMP (Simple Network Management Protocol). SNMP is a management protocol of TCP/IP (Transmission Control Protocol/Internet Protocol). A wide-area Ethernet has a plurality of relay apparatuses (e.g., LAN switches). Telecommunications carriers detect failures in the relay apparatuses and lines, thereby administering and maintaining the network itself.

In the network administration and maintenance using SNMP, remote LAN switches may not be managed with SNMP. The maintenance with SNMP does not allow determining whether a causal event has occurred at the Layer 3 that is an IP layer or at the Layer 2 that is an Ethernet layer. In a wide-area Ethernet, another technique exists for maintaining and administering various events occurring at the Layer 2 that is an Ethernet layer.

Generally, a technique of maintaining and administering various events occurring at the Layer 2 has been standardized as “Y.1731” by ITU-T (International Telecommunication Union-Telecommunication Standardization Sector). Also, Ethernet-OAM (Ethernet-Operations Administration Maintenance), for which standardization work is proceeding as “IEEE 802.1ag” in IEEE (The Institute of Electrical and Electronics Engineers, Inc), has come into use. This Ethernet-OAM will be used in the present embodiments.

Ethernet-OAM is a standard for maintaining and administering various events occurring at the Layer 2. Specifically, functions such as a CC (Continuity Check) function, LB (LoopBack) function, and LT (Link Trace) function are used to maintain and administer various events occurring at the Layer 2.

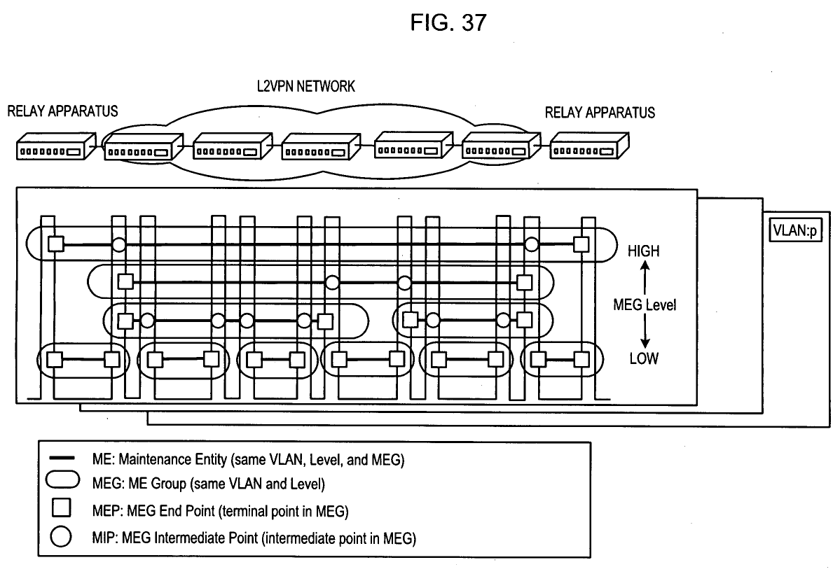

Ethernet-OAM has nomenclature shown in FIG. 37. An administered group is called an MEG (Maintenance Entity Group). A terminating apparatus in an MEG is called an MEP (MEG End Point). A relay apparatus in an MEG is called an MIP (MEG Intermediate Point). A communication segment between two MEPs is called an ME (Maintenance Entity).

Each will be described in detail. An ME is a segment in which various tests are performed by using OAM frames. An MEG is a set of MEs. For example, an MEG includes only one ME in the case of P2P connection, while including a plurality of different MEs in the case of multipoint connection. An MEG is assigned an ID (a character string) called an MEGID. The MEGID is defined differently in ITU-T and IEEE.

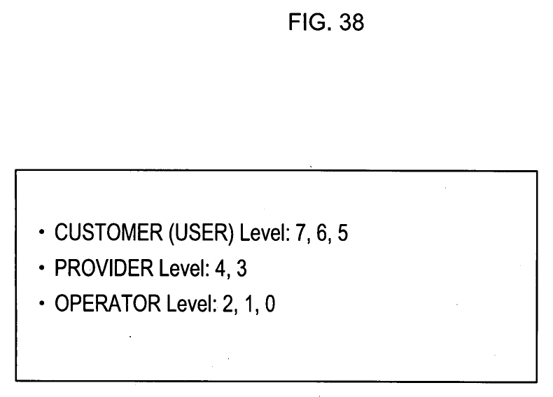

An MEG has levels defined for limiting the operation of MEPs and MIPs included in the MEG. Specifically, these MEG levels are for clearly distinguishing and separating a process flow in an MEG from a process flows in other MEGs. Eight (0 to 7) levels exist, and FIG. 38 shows default level assignment. The levels shown in FIG. 38 are stored in all Ethernet-OAM frames and checked in an apparatus that has received an OAM frame.

An MEP is located at a terminal point in an MEG and generates and terminates (captures) OAM frames for performing failure management and performance measurement. For frames other than OAM frames, an MEP does not terminate the frames but performs only monitoring (such as counting the number of frames). An MEP is assigned an ID (a number in the range from 1 to 8191) called an MEPID, which uniquely exists in an MEG. An MIP is located at an intermediate point in an MEG and performs processing for various kinds of OAM frames. An MIP does not generate or terminate OAM frames and does not have an ID.

Thus, Ethernet-OAM described above is effective for failure detection, failure management, failure point isolation, and so on in an interconnection environment at the Layer 2. To perform various tests using this Ethernet-OAM, it is necessary to recognize the above-described Ethernet-OAM elements in a network in question (e.g., which apparatuses are MEPs or MIPs). In a commonly used method, “VLANID, Level, MAC address, management type (MEP/MIP), MEP ID” and so on for each of the above-described Ethernet-OAM elements are set in a monitoring apparatus in advance by an administrator or the like.

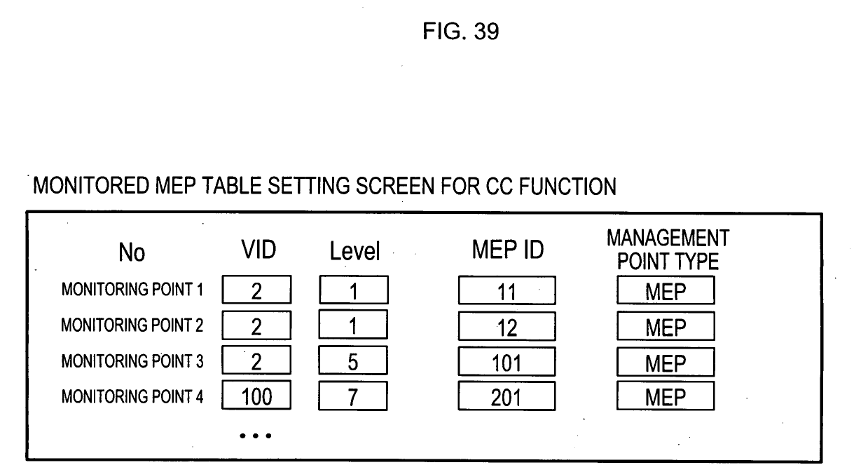

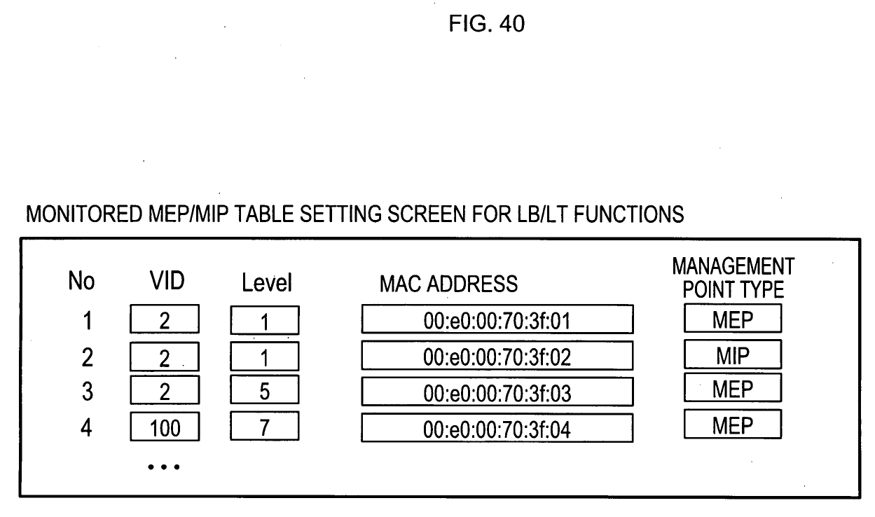

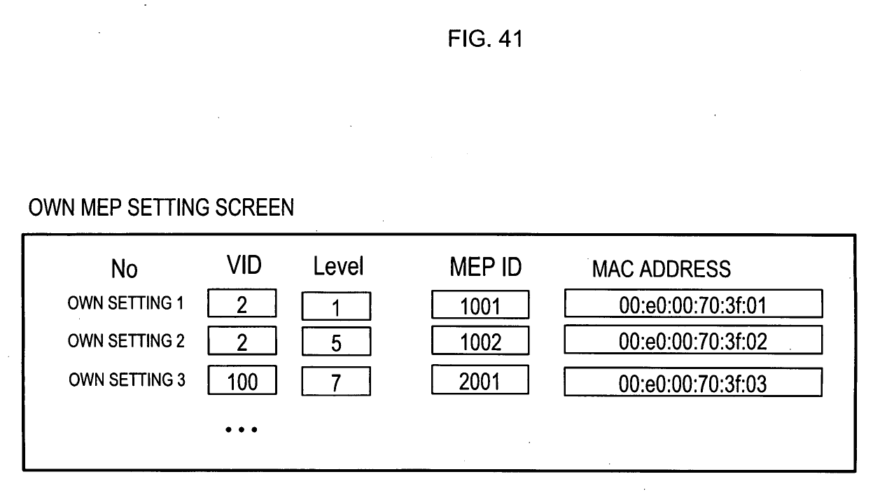

Specifically, a testing apparatus that performs tests by using Ethernet-OAM receives configuration information from an administrator or the like. The administrator sets the configuration information on screens such as a monitored MEP table setting screen for the CC function as shown in FIG. 39, a monitored MEP/MIP table setting screen for the LB/LT functions as shown in FIG. 40, and an own MEP setting screen as shown in FIG. 41. The testing apparatus performs the tests based on the received information. For a large-scale network, setting and storing the elements takes much effort. In addition, maintenance work for the setting information such as node addition and deletion takes much effort.

In the present embodiments, necessary configuration information and network information are automatically acquired for performing various network-related tests by using a maintenance protocol.

A network has communication apparatuses. A communication apparatus according to the embodiments is communicatively interconnected to a plurality of communication apparatuses in compliance with a maintenance protocol. The communication apparatus has the following functions. An LBM frame transmission unit transmits an LBM frame to the network by using a multicast LB function of the maintenance protocol. An MEP information acquisition unit identifies a communication apparatus having transmitted an LBR frame as an MEP when the LBR frame is received as a response to the LBM frame transmitted by the LBM frame transmission unit, and acquires MEP information indicating information about the MEP from the LBR frame. An LTM frame transmission unit transmits an LTM frame using a multicast LT function of the maintenance protocol to the MEP identified by the MEP information acquisition unit. An MIP information acquisition unit identifies a communication apparatus as an MIP from an LTR frame when the LTR frame is received as a response to the LTM frame transmitted by the LTM frame transmission unit, and acquires MIP information indicating information about the MIP. A topology information generation unit generates topology information representing a configuration of the network from the MEP information acquired by the MEP information acquisition unit and the MIP information acquired by the MIP information acquisition unit.

A CC information extraction unit receives a CCM frame transmitted by using a multicast CC function of the maintenance protocol from the communication apparatus identified as the MEP by the MEP information acquisition unit, and extracts an MEPID and a CC periodical transmission interval from the CCM frame.

The topology information generation unit graphically displays the generated topology information on a predetermined display unit.

The LBM frame transmission unit transmits the LBM frame to the network at predetermined intervals by using the multicast LB function of the maintenance protocol. The LTM frame transmission unit transmits the LTM frame using the multicast LT function of the maintenance protocol to the MEP identified by the MEP information acquisition unit.

It is also possible to cause a computer to perform these functions.

According to the embodiments, an LBM frame is transmitted to the network by using the multicast LB function of the maintenance protocol. When an LBR frame is received as a response to the transmitted LBM frame, a communication apparatus having transmitted the LBR frame is identified as an MEP, and MEP information indicating information about the MEP is acquired from the LBR frame. An LTM frame using the multicast LT function of the maintenance protocol is transmitted to the identified MEP. When an LTR frame is received as a response to the transmitted LTM frame, a communication apparatus is identified as an MIP from the LTR frame, and MIP information indicating information about the MIP is acquired. From the acquired MEP information and MIP information, topology information representing a configuration of the network is generated. Thus, an administrator can reduce the effort required in performing various network-related tests by using the maintenance protocol because necessary configuration information and network information can be automatically acquired.

Further, the topology information can be collected from the network to perform tests dynamically in a plug-and-play manner without the need to store the network information. Therefore, the administrator can increase the efficiency of his work. The administrator can further reduce setting mistakes and so on. In addition, monitoring and performance measurement for the Ethernet-OAM network topology can be automated.

A CCM frame transmitted by using the multicast CC function of the maintenance protocol is received from the communication apparatus identified as the MEP, and the MEPID and the CC periodical transmission interval are extracted from the CCM frame. Therefore, information for performing the CC function can further be automatically acquired.

The generated topology information is graphically displayed on the predetermined display unit. Therefore, the network configuration readily recognizable at a glance by the administrator or the like can be provided.

The LBM frame is transmitted to the network at predetermined intervals by using the multicast LB function of the maintenance protocol, and the LTM frame using the multicast LT function of the maintenance protocol is transmitted to the identified MEP. Therefore, modifications to the network configuration can be quickly addressed.

### First Embodiment

Description of Terminology

First, main terms used in the embodiments will be described. A “communication apparatus” as used in the embodiments refers to an apparatus implementing the Ethernet-OAM protocol. The Ethernet-OAM protocol is a standard for maintaining and administering various events occurring at the Layer 2 as a maintenance protocol in relay apparatuses such as L2 switches used for network construction. In this regard, a “communication apparatus” as used in the embodiments refers to a data relay apparatus such as an L2 switch, or a computer apparatus that performs various tests by using Ethernet-OAM.

In this Ethernet-OAM protocol, OAM frames serving as checkup (test) frames are transmitted and received across communication apparatuses to be maintained and administered. Thus, the Ethernet-OAM protocol has functions of performing tests such as CC (Continuity Check), LB (LoopBack), and LT (Link Trace). Specifically, a communication apparatus having received an OAM frame from another communication apparatus sees an OPCODE of the OAM frame and performs a test of any of the above CC, LB, and LT. The OPCODE included in the OAM frame indicates the test type. OPCODE=1 is designated for performing the test of the CC function, OPCODE=2 or 3 is designated for performing the test of the LB function, OPCODE=4 or 5 is designated for performing the test of the LT function, and so on.

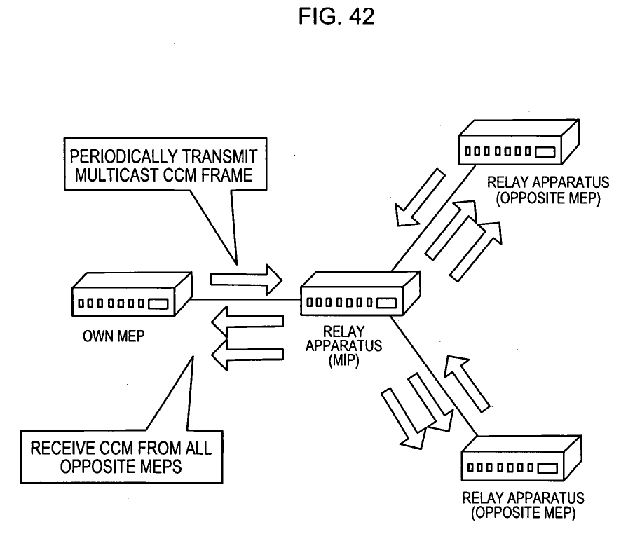

Each function will be described in detail. The CC function is a function for constantly monitoring the connectivity between the own apparatus (MEP) and a plurality of opposite apparatuses (MEPs) to detect the occurrence of a continuity break, incorporation, and loop. Specifically, as shown in FIG. 42, the CC function checks the connection with the opposite MEPs by receiving a multicast CCM frame or unicast CCM frame periodically transmitted by the opposite MEPs. The CC function can also check the connectivity with the own apparatus in the opposite MEPs by periodically transmitting a multicast CCM frame or unicast CCM frame from the own apparatus to the connected other MEPs.

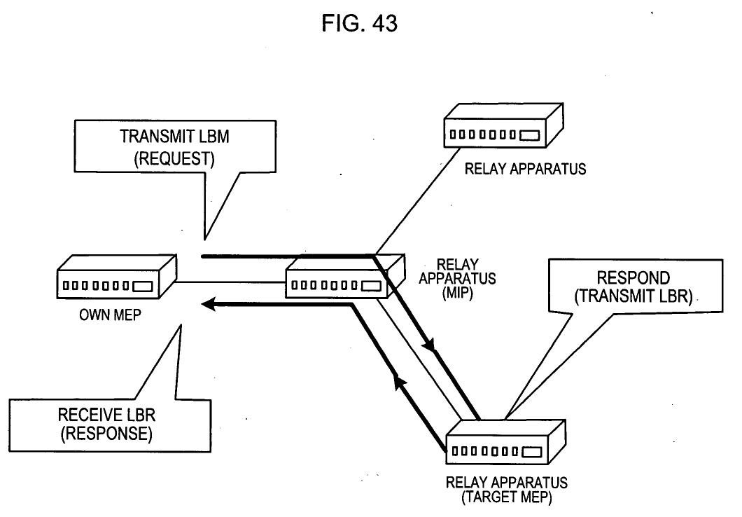

The LB function is a function for checking the bidirectional connectivity between the own apparatus (MEP) and one target opposite apparatus (MEP/MIP). Specifically, as shown in FIG. 43, the LB function checks the bidirectional connectivity by transmitting an LBM frame to the target MEP (or MIP) and receiving an LBR frame from the target MEP (or MIP) as a response to the LBM frame.

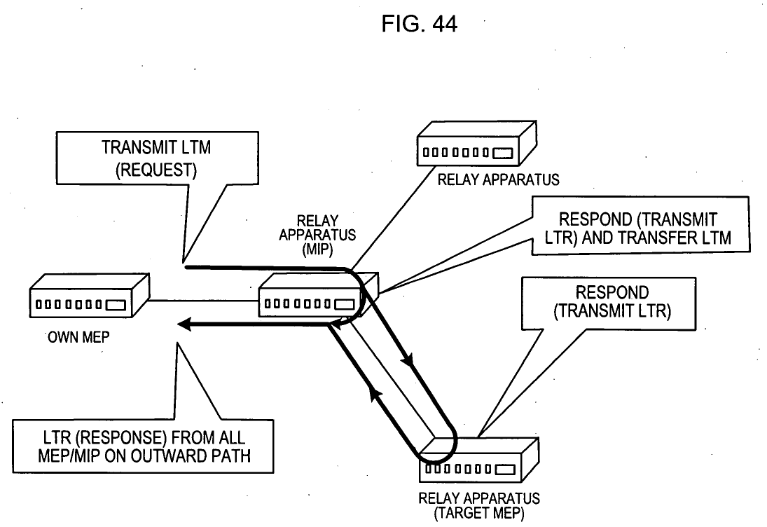

The LT function is a function for checking the path between the own apparatus (MEP) and one target opposite apparatus (MEP/MIP). Because of the ability to check the path, the LT function is utilized for identifying a failure point on the occurrence of a disconnection. Specifically, as shown in FIG. 44, the LT function transmits an LTM frame to the target MEP (or MIP), and an MIP on the path transmits an LTR frame to the originating MEP and also transfers the LTM frame to another apparatus. Eventually, the target MEP (or MIP) transmits an LTR frame in response to the LTM frame transmitted from the own apparatus, and therefore the LT function can receive LTR frames from all of the MEP and MIPs on the path from the own apparatus to the target MEP (or MIP), and check the outward path from the own apparatus to the target.

Thus, in communication apparatuses (e.g., L2 switches) used for network construction, the Ethernet-OAM protocol having the above-described functions can maintain and administer various events occurring at the Layer 2. Therefore, it is important to recognize how each communication apparatus connected to the network is connected and which role in Ethernet-OAM each communication apparatus plays.

Overview and Characteristics of Communication Apparatus

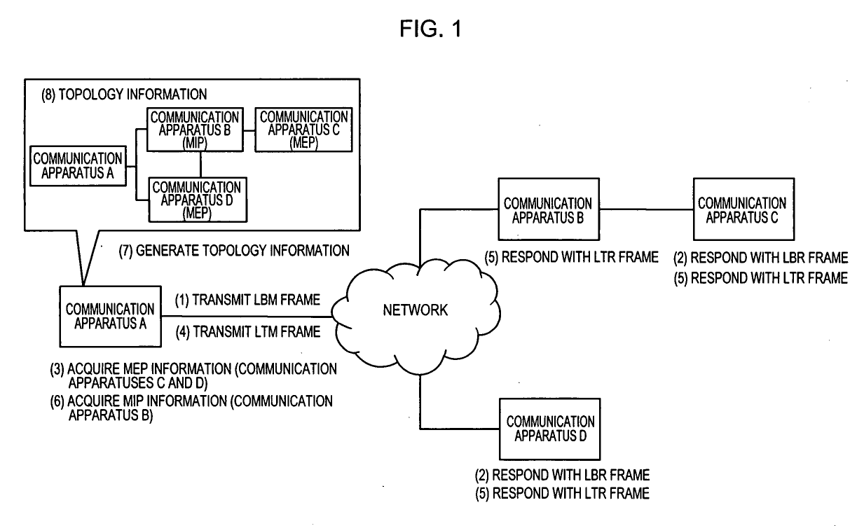

Now, with reference to FIG. 1, the overview and characteristics of communication apparatuses according to a first embodiment will be described. FIG. 1 is a diagram generally showing a network system including the communication apparatuses according to the first embodiment.

As shown in FIG. 1, this system has a communication apparatus A, a communication apparatus B, a communication apparatus C, and a communication apparatus D communicatively interconnected. These communication apparatuses A to D are apparatuses implementing Ethernet-OAM as a maintenance protocol, and the embodiments will be described for the cases where the communication apparatus A performs various tests by using Ethernet-OAM. Each of the communication apparatuses A to D is aware of apparatuses to which they are connected, but not yet aware of the roles in Ethernet-OAM (e.g., MEP or MIP).

In this state, as described above, the communication apparatus A according to the first embodiment is communicatively interconnected to a plurality of communication apparatuses in compliance with Ethernet-OAM, which is a maintenance protocol. For performing various network-related tests by using the maintenance protocol, the communication apparatus A can automatically acquire necessary configuration information and network information.

The communication apparatus A transmits an LBM frame to the network by using the multicast LB function of the Ethernet-OAM protocol (see (1) in FIG. 1). To specifically describe with an example, the communication apparatus A transmits an LBM frame to the communication apparatuses B to D by using the multicast LB function of the Ethernet-OAM protocol.

Subsequently, when the communication apparatus A receives LBR frames as responses to the transmitted LBM frame, the communication apparatus A identifies communication apparatuses having transmitted the LBR frames as MEPs and acquires MEP information indicating information about the MEPs from the LBR frames (see (2) and (3) in FIG. 1). To specifically describe with the above example, terminating apparatuses in the network respond to the LBM frame transmitted by the communication apparatus A; therefore, the communication apparatuses C and D except the communication apparatus B transmit an LBR frame to the communication apparatus A as a response to the LBM frame. The communication apparatus A recognizes that the transmitters (responding apparatuses) are the communication apparatuses C and D from the received LBR frames, and registers these apparatuses as “MEPs.” The communication apparatus A also acquires “VLAN ID,” “Level,” “MAC address,” and so on as the MEP information from the received LBR frames.

The communication apparatus A then transmits an LTM frame using the multicast LT function of the Ethernet-OAM protocol to the identified MEPs (see (4) in FIG. 1). To specifically describe with the above example, the communication apparatus A transmits an LTM frame using the multicast LT function of the Ethernet-OAM protocol to each of the communication apparatuses C and D having responded with the LBR frames for the transmitted LBM frame and identified as MEPs.

Thereafter, when the communication apparatus A receives LTR frames as responses to the transmitted LTM frame, the communication apparatus A identifies a communication apparatus as MIPs from the LTR frames and acquires MIP information indicating information about the MIPs (see (5) and (6) in FIG. 1). To specifically describe with the above example, for the LTM frame transmitted to each of the communication apparatuses C and D identified as MEPs by the communication apparatus A, all apparatuses on the path between the communication apparatus A and each MEP respond to the communication apparatus A; therefore, each of the communication apparatuses B to D transmits an LTR frame to the communication apparatus A. The communication apparatus A acquires the MIP information in which whether each of the communication apparatuses B to D is an upstream or downstream apparatus relative to the own apparatus is determined based on the TTL (Time To Live) and so on of the received LTR frame. As a result, the communication apparatus A registers “the communication apparatus B=MIP.”

The communication apparatus A generates topology information representing the configuration of the network from the acquired MEP information and MIP information (see (7) in FIG. 1). To specifically describe with the above example, based on the MEP information acquired from the LBR frames and the MIP information acquired from the LTR frames, the communication apparatus A generates topology information shown at (8) in FIG. 1 indicating “the communication apparatus B=MIP,” “the communication apparatus C=MEP,” and “the communication apparatus D=MEP.”

Thus, with the above-described main characteristics, the communication apparatus A according to the first embodiment can automatically acquire the necessary configuration information and network information for performing various network-related tests by using the maintenance protocol. This ability to automatically acquire the configuration information and network information allows reducing the information setting effort of an administrator or the like.

Communication Apparatus A

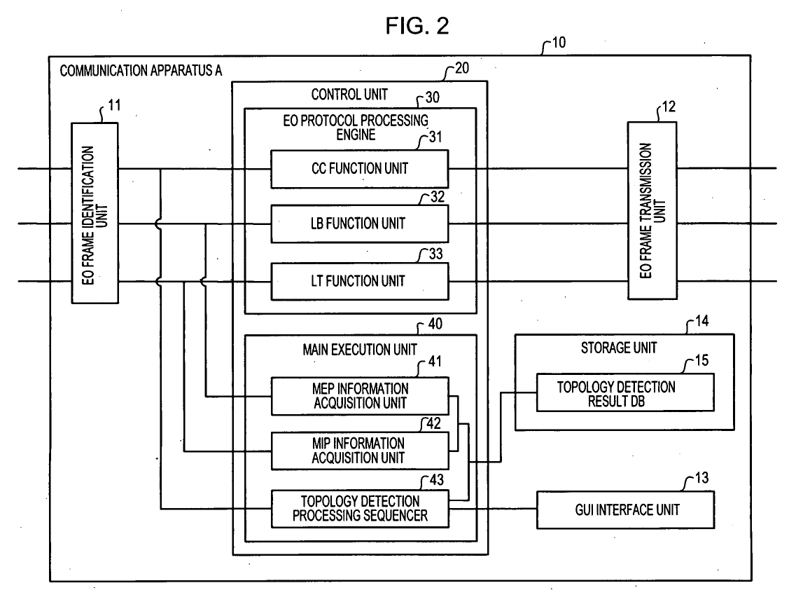

Now, with reference to FIG. 2, the communication apparatus A shown in FIG. 1 will be described. FIG. 2 is a block diagram showing the communication apparatus A according to the first embodiment. As shown in FIG. 2, this communication apparatus A 10 has an EO frame identification unit 11, an EO frame transmission unit 12, a GUI interface unit 13, a storage unit 14, and a control unit 20.

The EO frame identification unit 11 receives an OAM frame from a connected communication apparatus, identifies the received OAM frame, and notifies a corresponding function unit. To take a specific example, if the received OAM frame is a CC frame with the OPCODE of “1,” the EO frame identification unit 11 outputs the OAM frame to a CC function unit 31 and a topology detection processing sequencer 43 to be described later. If the received OAM frame is an LBM frame with the OPCODE of “3,” the EO frame identification unit 11 outputs the OAM frame to an LB function unit 32 to be described later. If the received OAM frame is an LBR frame with the OPCODE of “2,” the EO frame identification unit 11 outputs the OAM frame to an LB function unit 32 and the topology detection processing sequencer 43 to be described later.

Similarly, if the received OAM frame is an LTM frame with the OPCODE of “5,” the EO frame identification unit 11 outputs the OAM frame to an LT function unit 33 to be described later. If the received OAM frame is an LTR frame with the OPCODE of “4,” the EO frame identification unit 11 outputs the OAM frame to the LT function unit 33 and the topology detection processing sequencer 43 to be described later.

The EO frame transmission unit 12 transmits an OAM frame to a destination. To take a specific example, the EO frame transmission unit 12 transmits, to a destination, frames such as a CC frame, an LBM frame, an LBR frame, an LTM frame, and an LTR frame sent from the CC function unit 31, the LB function unit 32, and the LT function unit 33 to be described later.

The GUI interface 13 includes a monitor (or a display or touch panel) and a speaker. The monitor and the speaker output various kinds of information. To take a specific example, the GUI interface 13 graphically displays the topology information generated by the topology detection processing sequencer 43 to be described later.

The storage unit 14 stores data and programs necessary for various kinds of processing by the control unit 20. The storage unit 14 includes a topology detection result DB 15.

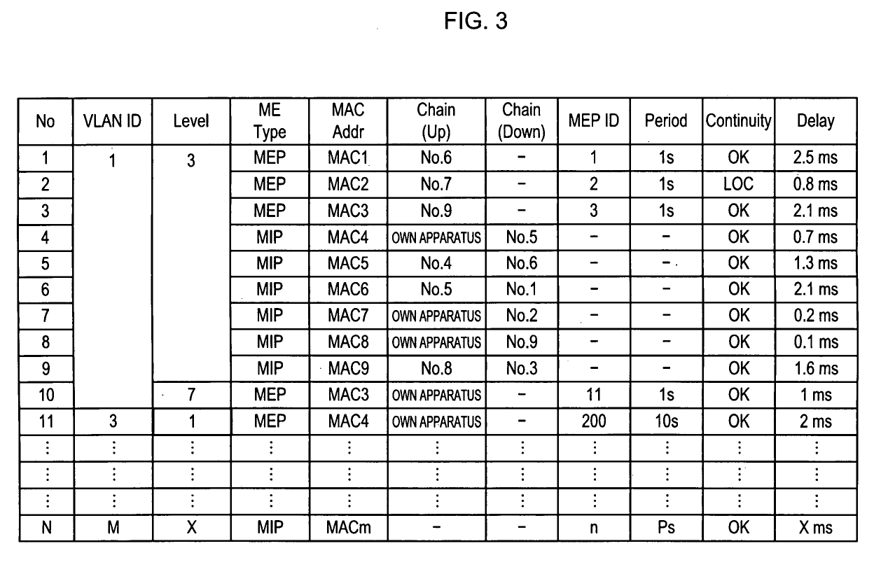

The topology detection result DB 15 stores the topology information generated by the topology detection processing sequencer 43, and various kinds of information acquired by an MEP information acquisition unit 41 and an MIP information acquisition unit 42. To take a specific example, as shown in FIG. 3, the topology detection result DB 15 stores information such as “‘No’ indicating an item number, ‘VLAN ID’ uniquely assigned to a VLAN to which a communication apparatus transmitting an OAM frame belongs, ‘Level’ indicating the level of an MEG to which a connected communication apparatus belongs, ‘ME Type’ indicating whether the connected communication apparatus is an MEP or an MIP, ‘MAC Addr’ indicating the MAC address of the connected communication apparatus, ‘Chain (Up)’ indicating an apparatus located upstream from the acquired communication apparatus, ‘Chain (Down)’ indicating an apparatus located downstream from the acquired communication apparatus, ‘MEP ID’ indicating the ID of an MEP transmitting and receiving an OAM frame, ‘Period’ indicating the CC frame transmission interval, ‘Continuity’ indicating the CC frame reception status, and ‘Delay’ indicating the communication delay between the own MEP and an opposite MEP.”

For example, as “No, VLAN ID, Level, ME Type, MAC Addr, Chain (Up), Chain (Down), MEP ID, Period, Continuity, Delay,” the topology detection result DB 15 stores “1, 1, 3, MEP, MAC1, No. 6, −, 1, 1 s, OK, 2.5 ms,” “2, 1, 3, MEP, MAC2, No. 7, −, 2, 1 s, LOC (Loss Of Continuity), 0.8 ms,” or “11, 3, 1, MEP, MAC 4, Own Apparatus, −, 200, 10 s, OK, 2 ms.”

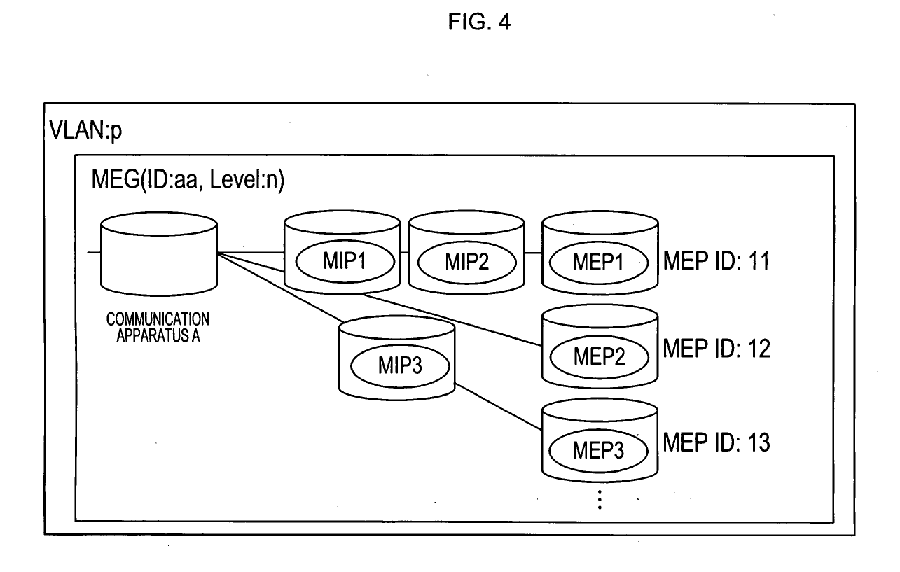

The topology detection result DB 15 also stores the topology information that graphically represents the information shown in FIG. 3. Specifically, the topology detection result DB 15 stores the topology information as shown in FIG. 4 generated by the topology detection processing sequencer 43 from the various kinds of information as shown in FIG. 3 acquired by the MEP information acquisition unit 41 and the MIP information acquisition unit 42. The information including various kinds of data and parameters shown in FIGS. 3 and 4 may be arbitrarily changed unless otherwise specified. FIG. 3 is a diagram showing exemplary information stored in the topology detection result DB, and FIG. 4 is a diagram showing exemplary topology information stored in the topology detection result DB.

The control unit 20 has internal memory for storing a control program such as an OS (Operating System), programs defining various procedures and so on, and necessary data. The control unit 20 includes an EO protocol processing engine 30 and a main execution unit 40, which are used by the control unit 20 to perform various kinds of processing.

The EO protocol processing engine 30 is a processing unit that operates as an MEP/MIP to perform various tests in Ethernet-OAM. The EO protocol processing engine 30 includes the CC function unit 31, the LB function unit 32, and the LT function unit 33.

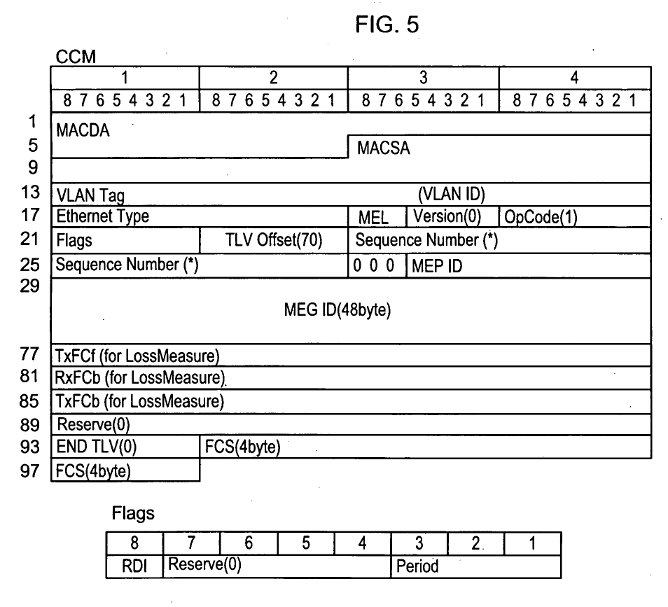

The CC function unit 31 performs the CC function in Ethernet-OAM. Specifically, the CC function unit 31 is a function for constantly monitoring the connectivity between the own apparatus (MEP) and a plurality of opposite apparatuses (MEPs) to detect the occurrence of a continuity break, incorporation, and loop by referring to the topology detection result DB 15 and multicasting a CCM frame as shown in FIG. 5 via the EO frame transmission unit 12. FIG. 5 is a diagram showing an exemplary CCM frame.

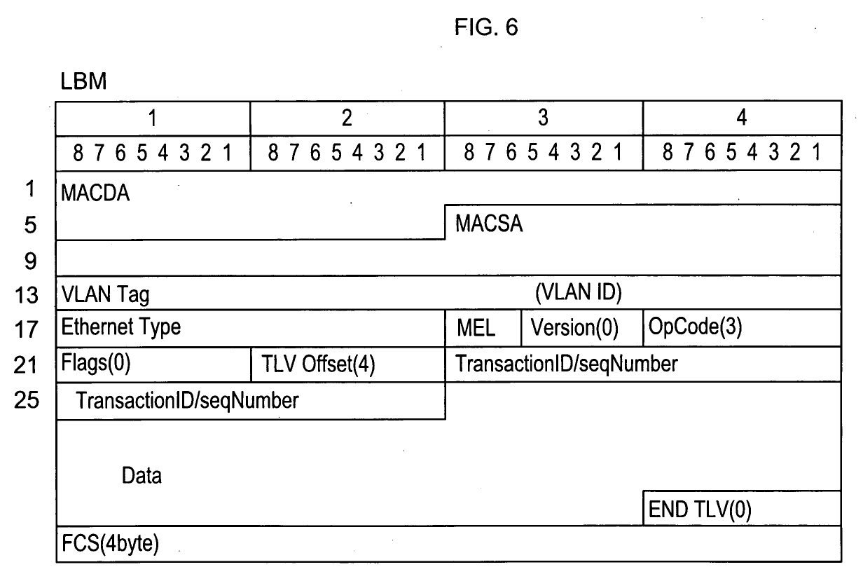

The LB function unit 32 transmits an LBM frame to the network at predetermined intervals by using the multicast LB function of the Ethernet-OAM protocol. Specifically, to acquire or update the network configuration (topology information), the LB function unit 32 multicasts an LBM frame as shown in FIG. 6 to the network at predetermined intervals (e.g., hourly).

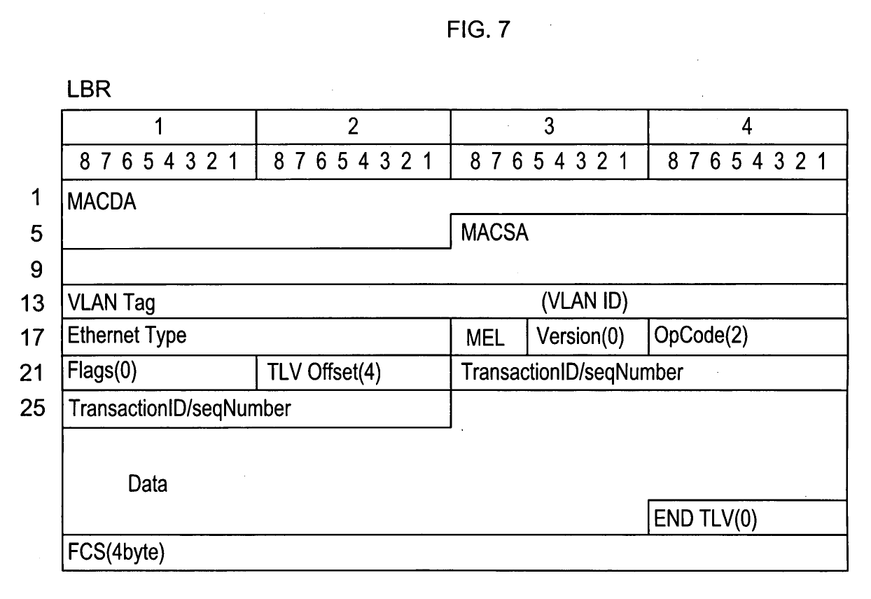

Also, to perform a test (the LB function) for checking the bidirectional connectivity between the own apparatus (MEP) and one target opposite apparatus (MEP/MIP), the LB function unit 32 checks the connection with the target by referring to the topology detection result DB 15, transmitting an LBM frame (see FIG. 6) to target MEPs (or MIPs) such as the communication apparatuses B to D, and receiving LBR frames as shown in FIG. 7 as responses thereto. FIG. 6 is a diagram showing an exemplary LBM frame, and FIG. 7 is a diagram showing an exemplary LBR frame. The LB function unit 32 corresponds to an “LBM frame transmission unit.”

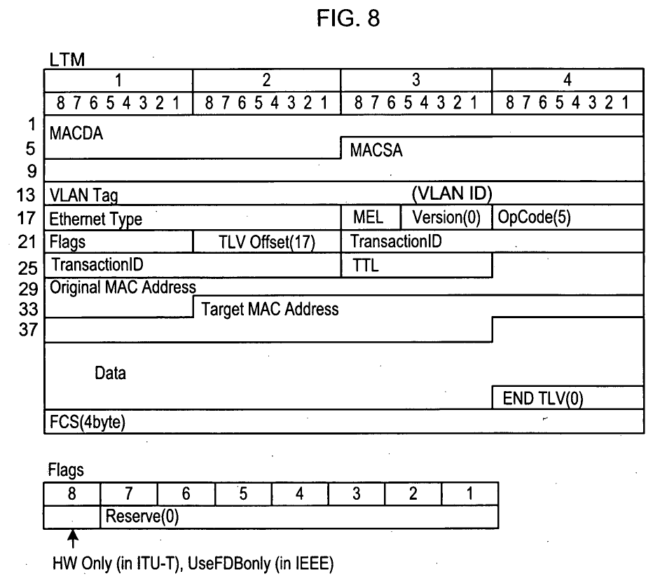

The LT function unit 33 transmits an LTM frame using the multicast LT function of the Ethernet-OAM protocol to MEPs identified by the MEP information acquisition unit 41 to be described later. To take a specific example, the LT function unit 33 receives LBR frames as responses to an LBM frame transmitted by the LB function unit 32. If the communication units C and D having transmitted the LBR frames are identified as MEPs by the MEP information acquisition unit 41 to be described later, the LT function unit 33 transmits an LTM frame as shown in FIG. 8 to the identified communication apparatuses C and D.

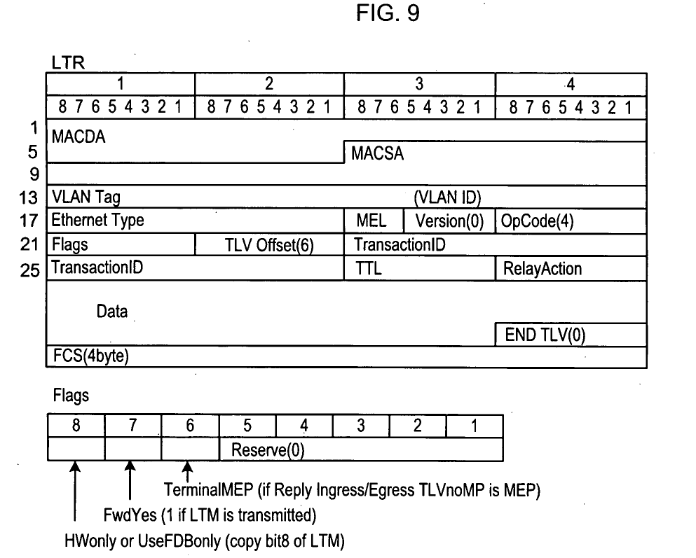

Also, to perform a test (the LT function) for checking the path between the own apparatus (the communication apparatus A: MEP) and one target opposite apparatus (MEP/MIP), the LT function unit 33 refers to the topology detection result DB 15 and transmits an LTM frame (see FIG. 8) to the target MEPs (or MIPs) such as the communication apparatuses B to D. An MIP on the path transmits an LTR frame as shown in FIG. 9 to the originating MEP and also transfers the LTM frame to another apparatus. Eventually, the target MEPs (or MIPs) transmit an LTR frame in response to the LTM frame transmitted from the own apparatus, and therefore the LT function unit 33 can receive LTR frames from all MEPs and MIPs on the paths from the own apparatus to the target MEPs (or MIPs), and check the outward paths from the own apparatus to the targets. FIG. 8 is a diagram showing an exemplary LTR frame. The LT function unit 33 corresponds to an “LTM frame transmission unit.”

The main execution unit 40 is a processing unit that circulates through VLANIDs and Levels and analyzes LB and LT responses in order to acquire information for the EO protocol processing engine 30 to perform various Ethernet-OAM tests. The main execution unit 40 includes the MEP information acquisition unit 41, the MIP information acquisition unit 42, and the topology detection processing sequencer 43. This main execution unit 40 is a function only required in apparatuses that perform various Ethernet-OAM tests. For example, if the communication apparatus B is not an apparatus that performs the tests, the communication apparatus B does not need to include the main execution unit 40.

The MEP information acquisition unit 41 identifies a communication apparatus having transmitted an LBR frame as an MEP and acquires the MEP information indicating information about the MEP from the LBR frame when the LBR frame is received as a response to an LBM frame transmitted by the LB function unit 32. To take a specific example, when LBR frames are received by the EO frame identification unit 11 as responses to an LBM frame transmitted by the LB function unit 32, the MEP information acquisition unit 41 identifies transmitters of the received LBR frames (the communication apparatuses C and D, which are terminating apparatuses in the network) as MEPs. The MEP information acquisition unit 41 acquires “VLANID, Level, MAC address” as the MEP information indicating information about the MEPs from the LBR frames and stores them in the topology detection result DB 15.

The MIP information acquisition unit 42 identifies a communication apparatus as an MIP from an LTR frame and acquires the MIP information indicating information about the MIP when the LTR frame is received as a response to an LTM frame transmitted by the LT function unit 33. To take a specific example, when an LTR frame is received by the EO frame identification unit 11 as a response to an LTM frame transmitted by the LT function unit 33, the MIP information acquisition unit 42 identifies, as an MIP, an apparatus (the communication apparatus B) having transmitted the received LTR frame and not been identified as an MEP. The MIP information acquisition unit 42 acquires “VLANID, Level, MAC address, Chain (Up), Chain (Down), Delay” as the MIP information indicating information about the MIP from the LTR frame and the TTL of the LTR frame, and stores them in the topology detection result DB 15.

The topology detection processing sequencer 43 receives a CCM frame transmitted by using the multicast CC function of the Ethernet-OAM protocol from a communication apparatus identified as an MEP by the MEP information acquisition unit 41. The topology detection processing sequencer 43 extracts the MEPID and the CC periodical transmission interval from the CCM frame and generates the topology information representing the network configuration from the MEP information acquired by the MEP information acquisition unit 41 and the MIP information acquired by the MIP information acquisition unit 42.

To take a specific example, the topology detection processing sequencer 43 receives CCM frames periodically transmitted from the communication apparatuses C and D identified as MEPs by the MEP information acquisition unit 41. The topology detection processing sequencer 43 extracts the MEPID and the CC periodical transmission interval (Period) from the CCM frames and stores them in the topology detection result DB 15. Since the CC frames are periodically transmitted, “‘Continuity’ indicating the connection status” stored in the topology detection result DB 15 is computed by the topology detection processing sequencer 43 from the previous and next frames and stored.

The topology detection processing sequencer 43 generates the topology information graphically showing a network configuration diagram from the MEP information acquired by the MEP information acquisition unit 41, the MIP information acquired by the MIP information acquisition unit 42, and the MEPID and the CC periodical transmission interval (Period) extracted from the CCM frames, stored in the topology detection result DB 15, and outputs the topology information to the GUI interface 13. The topology detection processing sequencer 43 stores the generated topology information in the topology detection result DB 15. The topology detection processing sequencer 43 corresponds to a “topology information generation unit” and a “CC information extraction unit.”

Processing by Communication Apparatus A

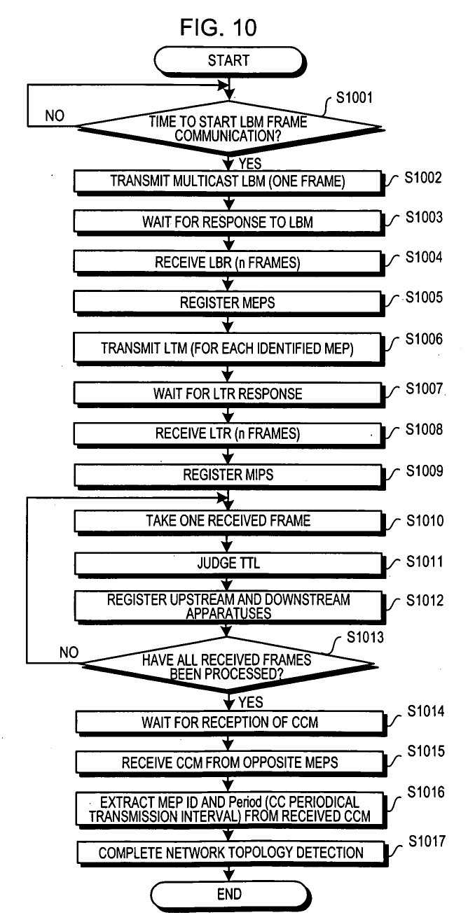

Now, processing by the communication apparatus A will be described with reference to FIG. 10. FIG. 10 is a flowchart showing a flow of network topology detection processing in the communication apparatus A according to the first embodiment. Various test processing using Ethernet-OAM in the communication apparatus A is the same as conventional processing and therefore will not be described here.

As shown in FIG. 10, when an LBM frame transmission time is reached (Yes in S1001), an LBM frame is transmitted to the network by using the multicast LB function of the Ethernet-OAM protocol of the communication apparatus A 10 (S1002).

The communication apparatus A 10 waits for LBR frames as responses to the LBM frame (S1003), and thereafter LBR frames are received by the EO frame identification unit 11 (S1004). The MEP information acquisition unit 41 of the communication apparatus A 10 identifies communication apparatuses having transmitted the received LBR frames as MEPs. The MEP information acquisition unit 41 acquires the MEP information indicating information about the MEPs from the LBR frames and stores the MEP information in the topology detection result DB 15 (S1005).

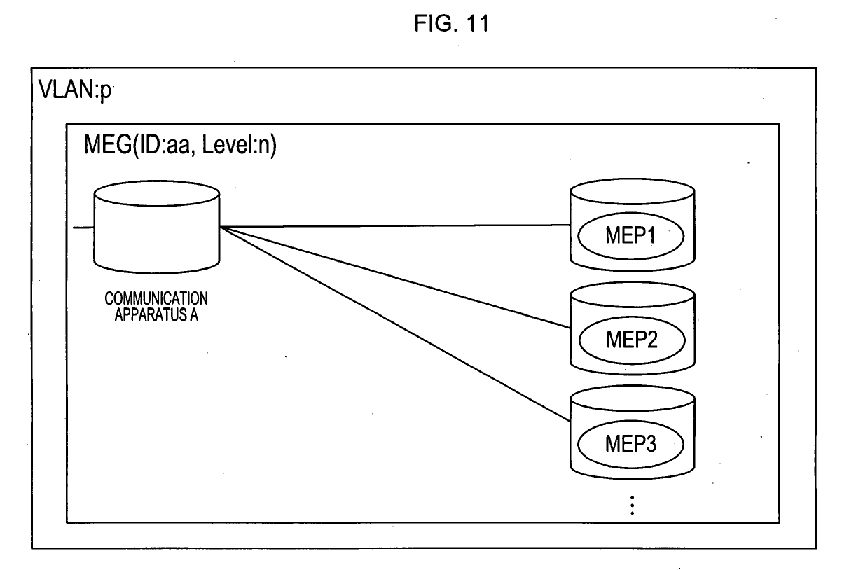

Here, the MEP information acquisition unit 41 can recognize all MEPs existing in the same MEG (a managed group with the same VLANID and MEGLevel values), and as a result, recognize connection relationships as shown in FIG. 11. FIG. 11 is a diagram showing exemplary topology information recognizable based on the MEP information.

Thereafter, the LT function unit 33 of the communication apparatus A 10 transmits an LTM frame for the identified MEPs (S1006). The communication apparatus A 10 then waits for LTR frames as responses to the LTM frame (S1007), and LTR frames are received by the EO frame identification unit 11 (S1008).

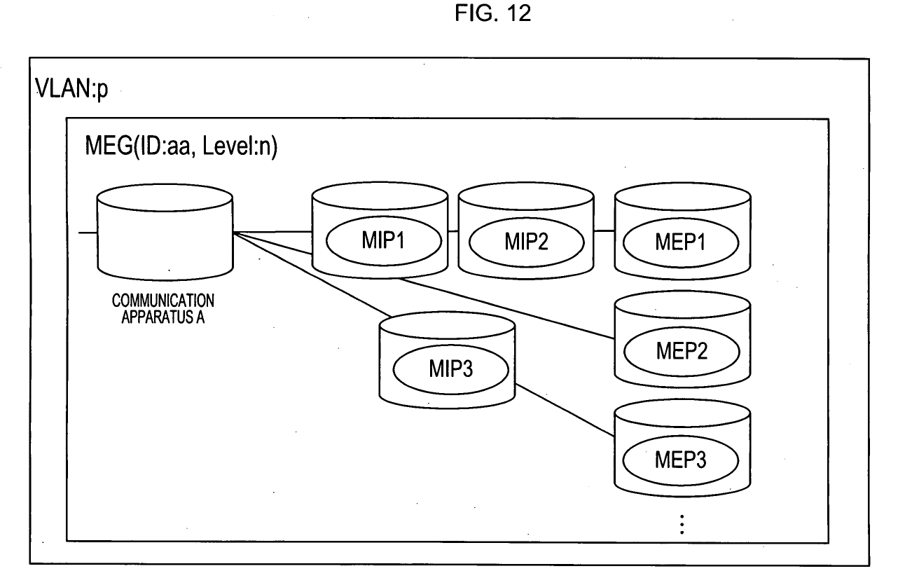

The MIP information acquisition unit 42 of the communication unit A 10 identifies communication apparatuses as MIPs from the received LTR frames and stores them in the topology detection result DB 15 (S1009). Here, the MIP information acquisition unit 42 can recognize all MIPs existing on the path to each MEP, and as a result, recognize connection relationships as shown in FIG. 12. FIG. 12 is a diagram showing exemplary topology information recognizable based on the MIP information.

Thereafter, the MIP information acquisition unit 42 of the communication unit A 10 takes one of the received LTR frames (S1010) and compares the TTL of this LTR frame with the TTL at which the own apparatus transmitted the LTM frame (S1011). The MIP information acquisition unit 42 identifies an upstream apparatus and a downstream apparatus for the apparatus having responded with the LTR frame, and stores them in the topology detection result DB 15 (S1012).

When the above process in S1010 and S1011 has been performed for all the received LTR frames (Yes in S1013), the communication apparatus A 10 waits for CCM frames (S1014), and CCM frames are received by the EO frame identification unit 11 (S1015).

The topology detection processing sequencer 43 of the communication apparatus A 10 then extracts the MEPID and Period (the CC periodical transmission interval) from the received CCM frames and stores them in the topology detection result DB 15 (S1016).

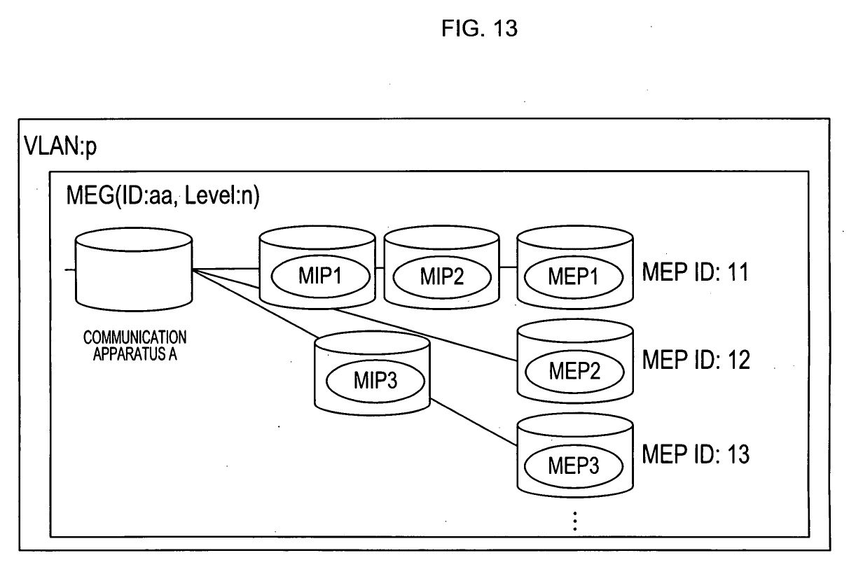

In this manner, the communication apparatus A 10 acquires configuration information items in Ethernet-OAM and thereby completes the network topology detection (S1017). As a result, the connection relationships as shown in FIG. 13 can be recognized. FIG. 13 is a diagram showing exemplary topology information recognizable based on the detected information.

### Advantages of First Embodiment

Thus, according to the first embodiment, an LBM frame is transmitted to the above-described network by using the multicast LB function of the Ethernet-OAM protocol. When LBR frames are received as responses to the transmitted LBM frame, communication apparatuses having transmitted the LBR frames are identified as MEPs, and the MEP information indicating information about the MEPs is acquired from the LBR frames. An LTM frame using the multicast LT function of the Ethernet-OAM protocol is transmitted to the identified MEPs. When LTR frames are received as responses to the transmitted LTM frame, communication apparatuses are identified as MIPs from the LTR frames and the MIP information indicating information about the MIPs is acquired. From the acquired MEP information and MIP information, the topology information representing the network is generated. Therefore, the configuration information and network information necessary for Ethernet-OAM can be automatically acquired for performing various network-related tests by using a maintenance protocol such as Ethernet-OAM.

For example, since apparatuses that should be MEPs and that should be MIPs in the network can be identified respectively, and the information such as “VLANID, Level, MAC address, management type (MEP/MIP), MEPID” for operation as MEPs/MIPs can be automatically acquired, these information items do not need to be manually set in a test apparatus. This allows significant reduction of the effort of an administrator. Further, the topology information can be collected from the network to perform tests dynamically in a plug-and-play manner without the need to store the network information. This can increase the efficiency of the work and reduce setting mistakes and so on. In addition, monitoring and performance measurement for the Ethernet-OAM network topology can be automated.

According to the first embodiment, CCM frames transmitted by using the multicast CC function of the Ethernet-OAM protocol are received from the communication apparatuses identified as MEPs, and the MEPID and the CC periodical transmission interval are extracted from the CCM frames. Therefore, information for performing the CC function can further be automatically acquired.

For example, since “‘Continuity’ indicating the connection status” can be automatically acquired, tests using the CC function can be performed and the network status can be accurately recognized.

According to the first embodiment, the generated topology information is graphically displayed. Therefore, the network configuration readily recognizable at a glance by the administrator or the like can be provided. For example, the ability to graphically recognize the network allows the administrator or the like to quickly identify a failure point (apparatus) on the occurrence of a failure and utilize the network configuration diagram to minimize the influence of the failure.

According to the first embodiment, an LBM frame is transmitted to the network at predetermined intervals by using the multicast LB function of the maintenance protocol, and an LTM frame using the multicast LT function of the maintenance protocol is transmitted to the identified MEPs. Therefore, modifications to the network configuration can be quickly addressed. For example, since the configuration information can again be automatically acquired when an apparatus has been added or deleted in the network, modifications to the network configuration can be quickly addressed.

### Second Embodiment

In the first embodiment, the way the communication apparatus A automatically collects the topology information about the Ethernet-OAM network has been conceptually described. In a second embodiment, this will be described with specific examples (first to fourth examples).

### First Example

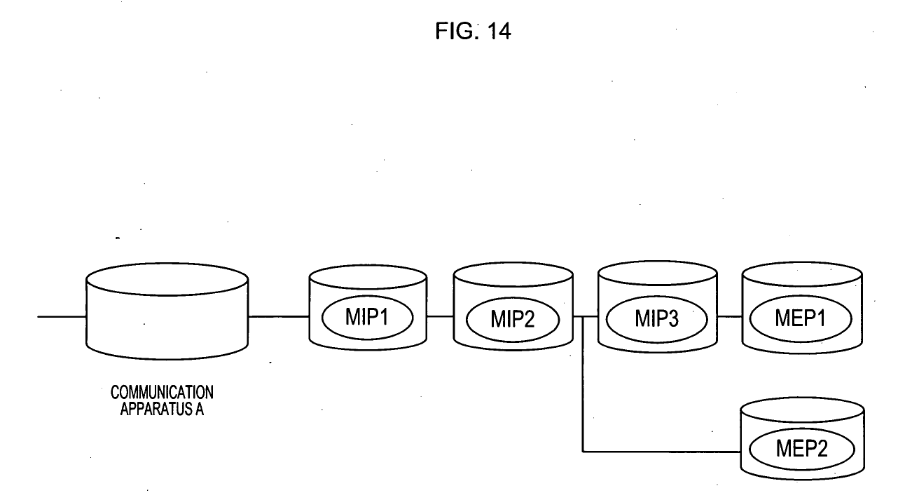

First, a first example will be described with reference to FIGS. 14 to 18. FIG. 14 is a diagram of a network in the first example collected in the second embodiment. In the first example, an example of collecting network information shown in FIG. 14 will be described. Since the communication apparatus A according to the second embodiment is yet to collect the network information, the communication apparatus A is not aware of the network topology shown in FIG. 14 until the collection is completed.

In this network, the LB function unit 32 of the communication apparatus A 10 transmits an LBM frame to the network by using the multicast LB function of the Ethernet-OAM protocol. Since only MEPs are to respond to this LBM frame, the EO frame identification unit 11 of the communication apparatus A receives LBR frames transmitted from an MEP1 and an MEP2 respectively.

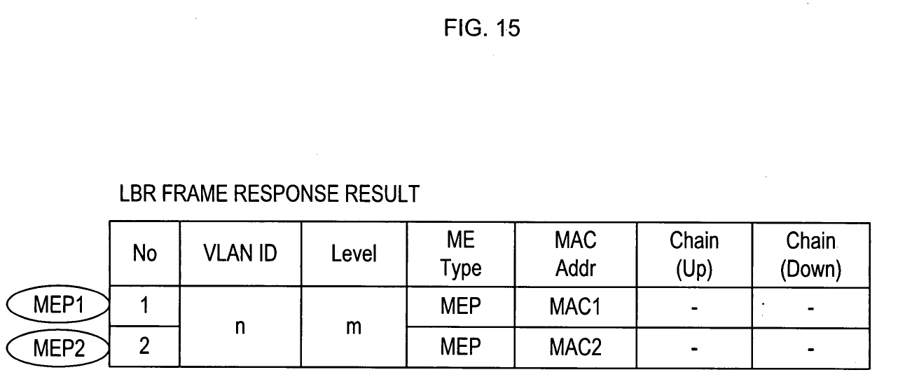

The MEP information acquisition unit 41 of the communication apparatus A recognizes the existence of the MEP1 and the MEP2 in the network shown in FIG. 14, and acquires “VLANID=n, Level=m, MAC address=MAC1, MAC2” as the MEP information from the respective received LBR frames and stores them in the topology detection result DB 15 (see FIG. 15). FIG. 15 is a diagram showing exemplary information that may be acquired after performing the LB function in the first example in the second embodiment.

The LT function unit 33 of the communication apparatus A then transmits an LTM frame using the multicast LT function of the Ethernet-OAM protocol to the MEPs identified by the MEP information acquisition unit 41. Since MEPs and MIPs are to respond to this LTM frame, the EO frame identification unit 11 of the communication apparatus A receives LTR frames transmitted from the MEP1, the MEP2, and MIPs respectively.

When the LTR frames are received as responses to the LTM frame transmitted from the LT function unit 33, the MIP information acquisition unit 42 of the communication apparatus A identifies communication apparatuses as MIPs from the LTR frames and acquires the MIP information indicating information about the MIPs.

Specifically, since all MEPs/MIPs are to respond, when the LTM frame (TTL=64) is transmitted to the MEP1 by the LT function unit 33, the MIP information acquisition unit 42 receives “an LTR frame (TTL=63) from the MIPL,” “an LTR frame (TTL=62) from the MIP2,” “an LTR frame (TTL=61) from MIP3,” and “an LTR frame (TTL=60) from the MEPL.” Also, when the LTM frame (TTL=64) is transmitted to the MEP2 by the LT function unit 33, the MIP information acquisition unit 42 receives “an LTR frame (TTL=63) from the MIPL,” “an LTR frame (TTL=62) from the MIP2,” and “an LTR frame (TTL=61) from the MEP2.”

Here, when an LTR frame with “TTL=63” is received, it can be known that the apparatus having transmitted the LTR frame with “TTL=63” is an apparatus connected to (next to) the communication apparatus A 10 because the LTM frame transmitted by the LT function unit 33 has “TTL=64.” Judging in this manner, the MIP information acquisition unit 42 can recognize that three apparatuses are connected between the communication apparatus A 10 and the MEP 1 based on the reception of the LTR frame with “TTL=60” from the MEP1, and that two apparatuses are connected between the communication apparatus A 10 and the MEP2 based on the reception of the LTR frame with “TTL=61” from the MEP2. By judging the TTL in this manner for all the received LTR frames, the MIP information acquisition unit 42 and the MEP information acquisition unit 41 can obtain the connection relationships between the communication apparatus A 10, the MIPs, and the MEPs.

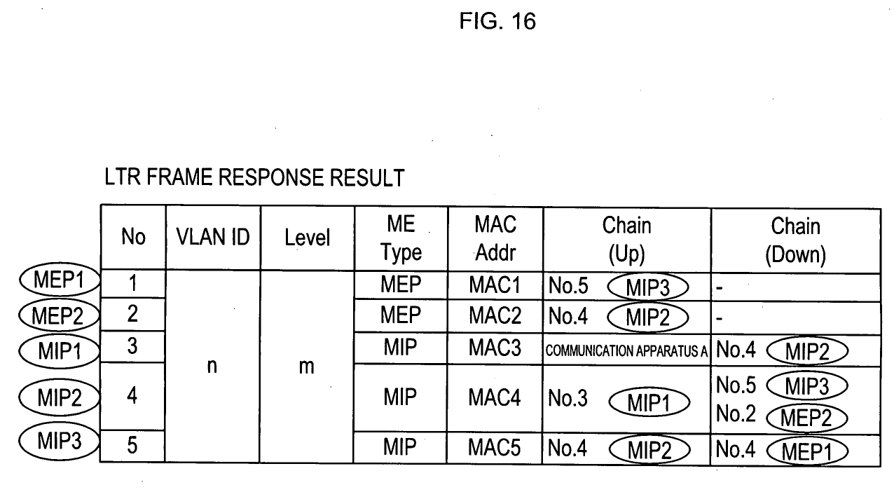

As a result, the MIP information acquisition unit 42 recognizes the existence of the MIP1, MIP2, and MIP3 in the network shown in FIG. 14, and acquires “VLANID=n, Level=m, ME type=MIP, MAC address=MAC3, Chain (Up)=Communication Apparatus A, Chain (Down)=No. 4 (MIP2),” “VLANID=n, Level=m, ME Type=MIP, MAC address=MAC4, Chain (Up)=No. 3 (MIP1), Chain (Down)=No. 5 (MIP3), No. 2 (MEP2),” and “VLANID=n, Level=m, ME type=MIP, MAC address=MAC5, Chain (Up)=No. 4 (MIP2), Chain (Down)=No. 4 (MEP1)” as the MIP information indicating information about the MIPs from the LTR frames and TTL of the LTR frames and stores them in the topology detection result DB 15 (see FIG. 16). FIG. 16 is a diagram showing exemplary information that may be acquired after performing the LT function in the first example in the second embodiment.

Similarly, for the MEPs, the MEP information acquisition unit 41 acquires “VLANID=n, Level=m, ME type=MEP, MAC address=MAC1, Chain (Up)=No. 5 (MIP3), Chain (Down)=-” and “VLANID=n, Level=m, ME type=MEP, MAC address=MAC2, Chain (Up)=No. 4 (MIP2), Chain (Down)=-” and stores them in the topology detection result DB 15.

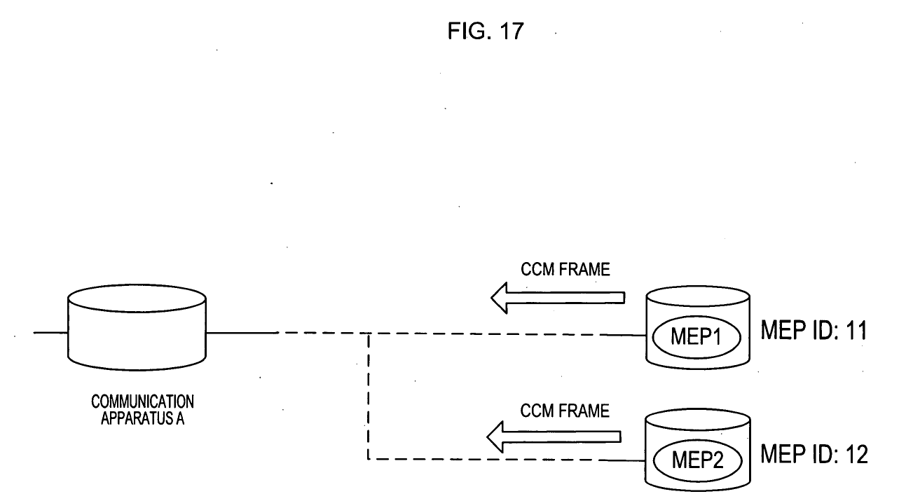

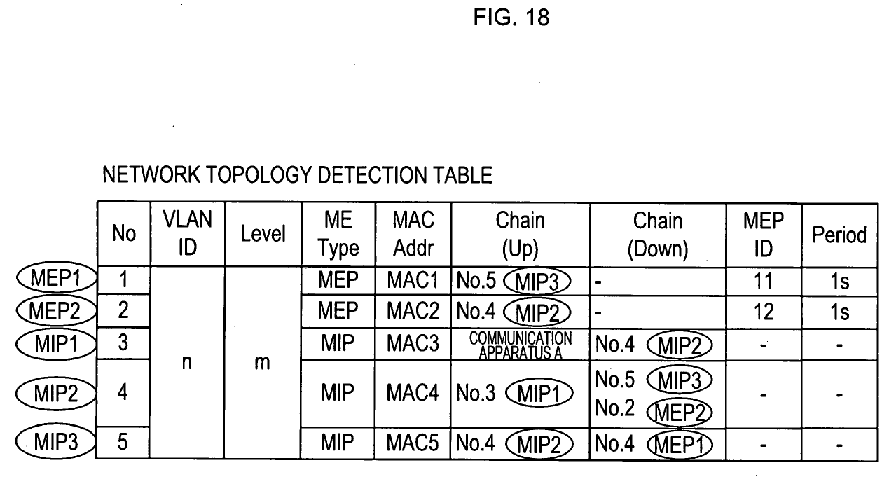

The communication apparatus A 10 then waits for reception of CCM frames. Thereafter, as shown in FIG. 17, the MEP1 and the MEP2 periodically transmit a CCM frame to the network, and the EO frame identification unit 11 of the communication apparatus A 10 receives the CCM frames. Therefore, the topology detection processing sequencer 43 detects the MEPID and Period of the MEP1 and the MEP2 and stores them in the topology detection result DB 15 (see FIG. 18). FIG. 17 is a diagram for illustrating the transmission of the CCM frames, and FIG. 18 is a diagram showing exemplary information that may be acquired after performing the CC function in the first example in the second embodiment.

Thus, the communication apparatus A 10 can acquire the network information shown in FIG. 14 with the LB function, LT function, and CC function. The communication apparatus A 10 can also perform monitoring and performance measurement periodically by using a cycle determined from the CC transmission interval (Period) or a cycle arbitrarily set by a user.

### Second Example

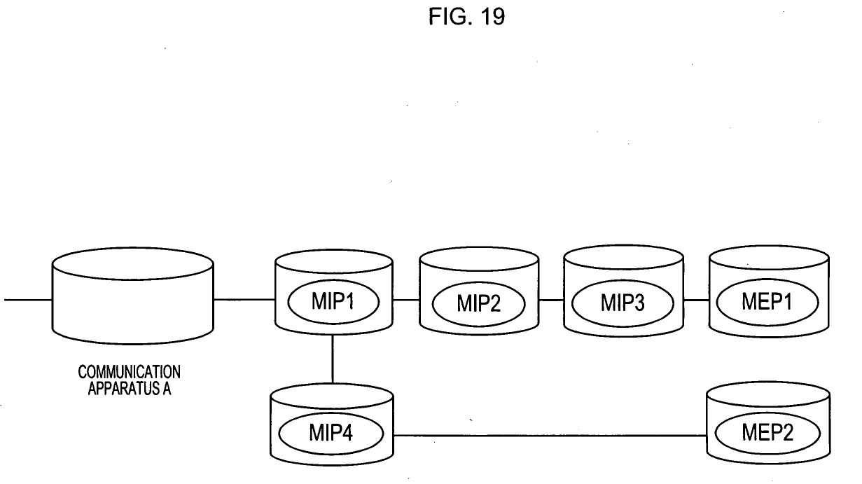

Now, a second example will be described with reference to FIGS. 19 to 23. FIG. 19 is a diagram of a network in the second example collected in the second embodiment. In the second example, an example of collecting network information shown in FIG. 19 will be described. As in the first example, since the communication apparatus A according to the second embodiment is yet to collect the network information, the communication apparatus A is not aware of the network topology shown in FIG. 19 until the collection is completed.

In this network, the LB function unit 32 of the communication apparatus A 10 transmits an LBM frame to the network by using the multicast LB function of the Ethernet-OAM protocol. Since only MEPs are to respond to this LBM frame, the EO frame identification unit 11 of the communication apparatus A receives LBR frames transmitted from an MEP1 and an MEP2 respectively.

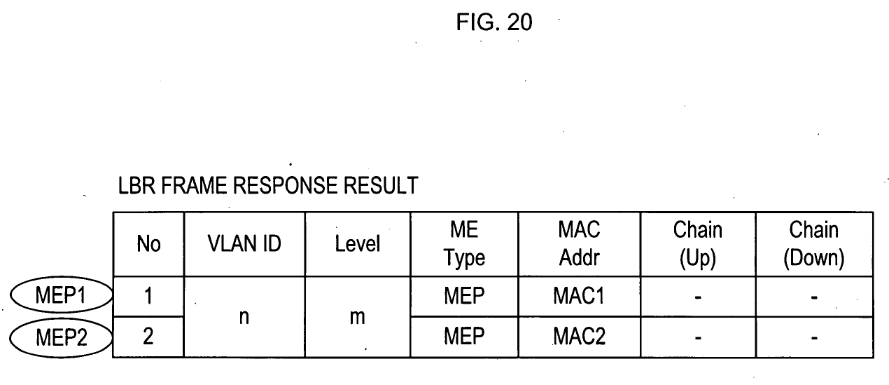

The MEP information acquisition unit 41 of the communication apparatus A recognizes the existence of the MEP1 and the MEP2 in the network shown in FIG. 19, and acquires “VLANID=n, Level=m, MAC address=MAC1, MAC2” as the MEP information from the respective received LBR frames and stores them in the topology detection result DB 15 (see FIG. 20). FIG. 20 is a diagram showing exemplary information that may be acquired after performing the LB function in the second example in the second embodiment.

The LT function unit 33 of the communication apparatus A then transmits an LTM frame using the multicast LT function of the Ethernet-OAM protocol to the MEPs identified by the MEP information acquisition unit 41. Since MEPs and MIPs are to respond to this LTM frame, the EO frame identification unit 11 of the communication apparatus A receives LTR frames transmitted from the MEP1, the MEP2, and MIPs, respectively.

When the LTR frames are received as responses to the LTM frame transmitted from the LT function unit 33, the MIP information acquisition unit 42 of the communication apparatus A identifies communication apparatuses as MIPs from the LTR frames and acquires the MIP information indicating information about the MIPs.

Specifically, when the LTM frame (TTL=64) is transmitted to the MEP1 by the LT function unit 33, the MIP information acquisition unit 42 receives “an LTR frame (TTL=63) from the MIP1,” “an LTR frame (TTL=62) from the MIP2,” “an LTR frame (TTL=61) from MIP3,” and “an LTR frame (TTL=60) from the MEP1.” Also, when the LTM frame (TTL=64) is transmitted to the MEP2 by the LT function unit 33, the MIP information acquisition unit 42 receives “an LTR frame (TTL=63) from the MIP1,” “an LTR frame (TTL=62) from the MIP4,” and “an LTR frame (TTL=61) from the MEP2.”

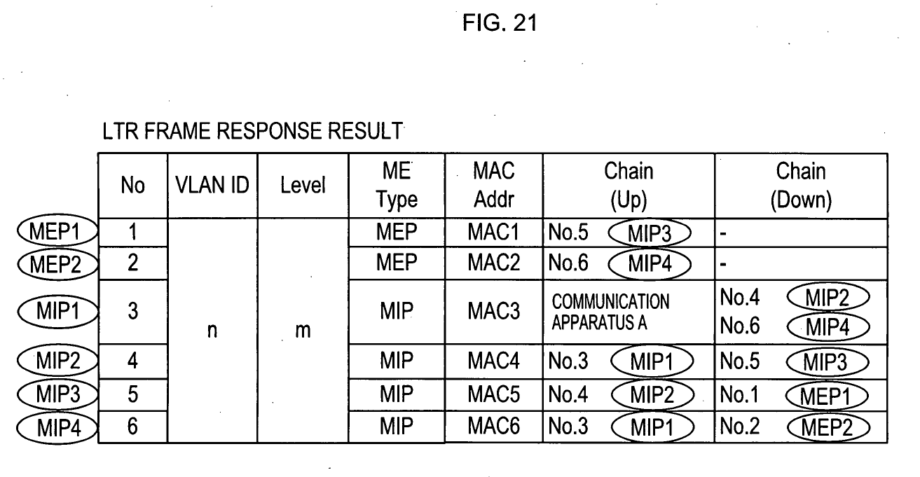

Here, by using the same approach as the above-described first example to check the TTL differences, the MIP information acquisition unit 42 recognizes the existence of the MIP1, MIP2, MIP3, and MIP4 in the network shown in FIG. 19, and acquires the position relationships between each apparatus and the MIP information and stores them in the topology detection result DB 15 (see FIG. 21). Similarly, for the MEPs, the MEP information acquisition unit 41 acquires an upstream apparatus and a downstream apparatus for each of the MEP1 and MEP2 and stores them in the topology detection result DB 15. FIG. 21 is a diagram showing exemplary information that may be acquired after performing the LT function in the second example in the second embodiment.

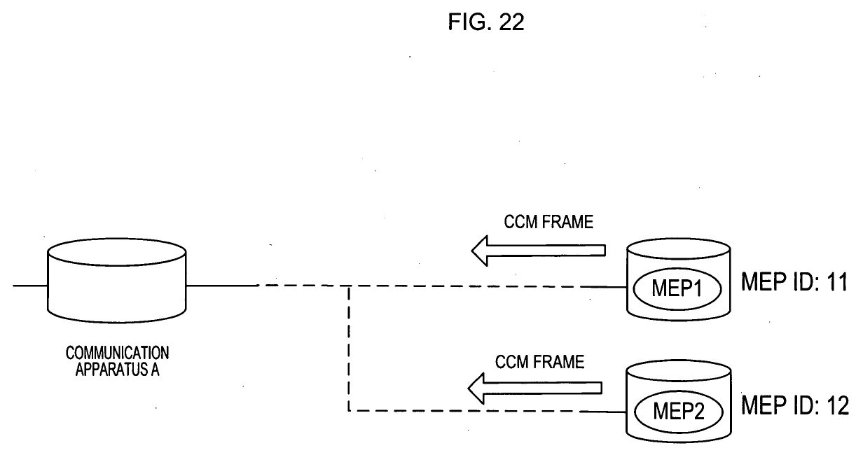

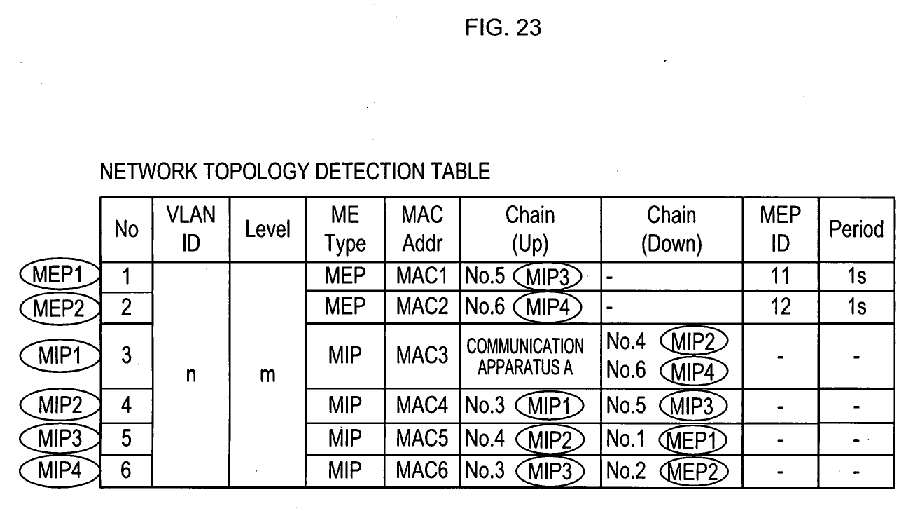

The communication apparatus A 10 then waits for reception of CCM frames. Thereafter, as shown in FIG. 22, the MEP1 and the MEP2 periodically transmit a CCM frame to the network, and the EO frame identification unit 11 of the communication apparatus A 10 receives the CCM frames. Therefore, the topology detection processing sequencer 43 detects the MEPID and Period of the MEP1 and the MEP2 and stores them in the topology detection result DB 15 (see FIG. 23). FIG. 22 is a diagram for illustrating the transmission of the CCM frames, and FIG. 23 is a diagram showing exemplary information that may be acquired after performing the CC function in the second example in the second embodiment.

Thus, the communication apparatus A 10 can acquire the network information shown in FIG. 19 with the LB function, LT function, and CC function. The communication apparatus A 10 can also perform monitoring and performance measurement periodically by using a cycle determined from the CC transmission interval (Period) or a cycle arbitrarily set by a user.

### Third Example

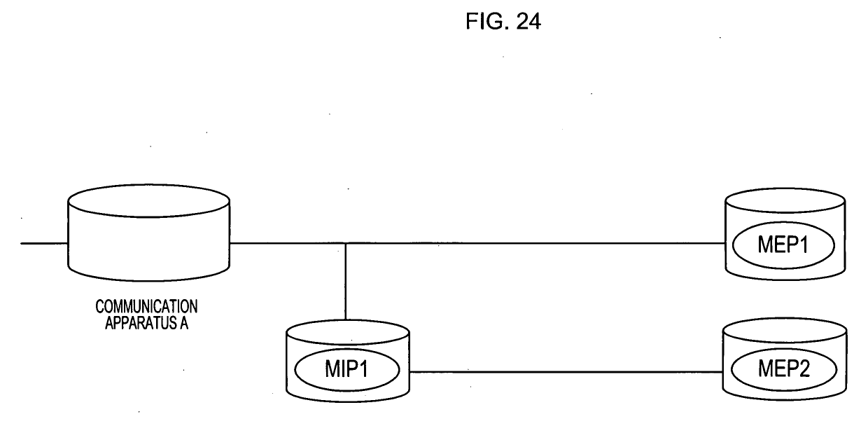

Now, a third example will be described with reference to FIGS. 24 to 28. FIG. 24 is a diagram of a network in the third example collected in the second embodiment. In the third example, an example of collecting network information shown in FIG. 24 will be described.

In this network, the LB function unit 32 of the communication apparatus A 10 transmits an LBM frame to the network by using the multicast LB function of the Ethernet-OAM protocol. Since only MEPs are to respond to this LBM frame, the EO frame identification unit 11 of the communication apparatus A receives LBR frames transmitted from an MEP1 and an MEP2 respectively.

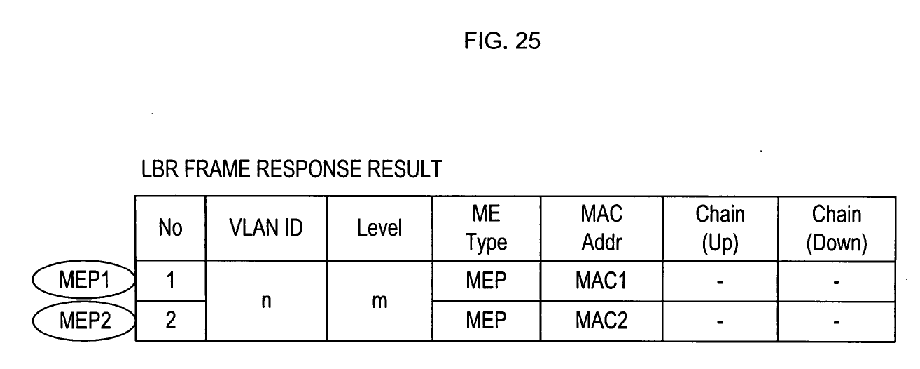

The MEP information acquisition unit 41 of the communication apparatus A recognizes the existence of the MEP1 and the MEP2 in the network shown in FIG. 24, and acquires “VLANID=n, Level=m, MAC address=MAC1, MAC2” as the MEP information from the respective received LBR frames and stores them in the topology detection result DB 15 (see FIG. 25). FIG. 25 is a diagram showing exemplary information that may be acquired after performing the LB function in the third example in the second embodiment.

The LT function unit 33 of the communication apparatus A then transmits an LTM frame using the multicast LT function of the Ethernet-OAM protocol to the MEPs identified by the MEP information acquisition unit 41. Since MEPs and MIPs are to respond to this LTM frame, the EO frame identification unit 11 of the communication apparatus A receives LTR frames transmitted from the MEP1, the MEP2, and an MIP, respectively.

When the LTR frames are received as responses to the LTM frame transmitted from the LT function unit 33, the MIP information acquisition unit 42 of the communication apparatus A identifies a communication apparatus as an MIP from the LTR frames and acquires the MIP information indicating information about the MIP.

Specifically, when the LTM frame (TTL=64) is transmitted to the MEP1 by the LT function unit 33, the MIP information acquisition unit 42 receives “an LTR frame (TTL=63) from the MEP1.” Also, when the LTM frame (TTL=64) is transmitted to the MEP2 by the LT function unit 33, the MIP information acquisition unit 42 receives “an LTR frame (TTL=63) from the MIP1” and “an LTR frame (TTL=62) from the MEP2.”

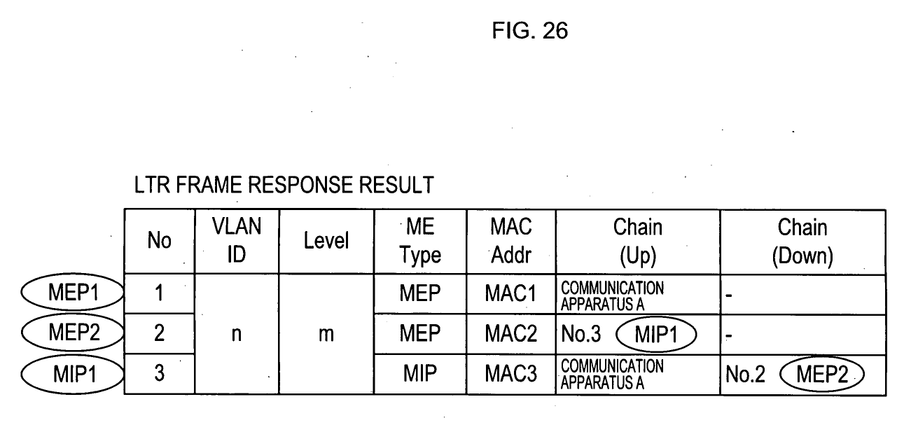

Here, by using the same approach as the above-described first example, the MIP information acquisition unit 42 recognizes that the MIP1 is connected between the communication apparatus A and the MEP2 based on the reception of the LTR frames with “TTL=63” from the MIP1 and “TTL=62” from the MEP2. Judging in this manner, the MIP information acquisition unit 42 recognizes the existence of the MIP1 in the network shown in FIG. 24, and acquires the position relationships between each apparatus and the MIP information and stores them in the topology detection result DB 15 (see FIG. 26). Similarly, for the MEPs, the MEP information acquisition unit 41 acquires an upstream apparatus (the MIP1) for the MEP2 and an upstream apparatus (the communication apparatus A 10) for the MEP1 and stores them in the topology detection result DB 15. FIG. 26 is a diagram showing exemplary information that may be acquired after performing the LT function in the third example in the second embodiment.

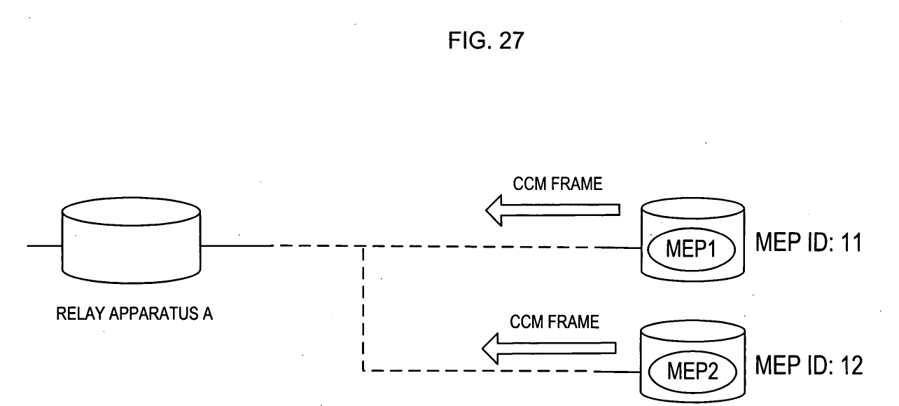

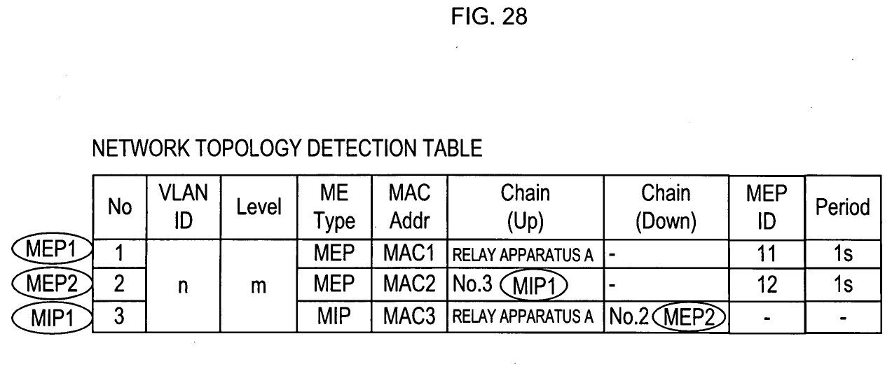

The communication apparatus A 10 then waits for reception of CCM frames. Thereafter, as shown in FIG. 27, the MEP1 and the MEP2 periodically transmit a CCM frame to the network, and the EO frame identification unit 11 of the communication apparatus A 10 receives the CCM frames. Therefore, the topology detection processing sequencer 43 detects the MEPID and Period of the MEP1 and the MEP2 and stores them in the topology detection result DB 15 (see FIG. 28). FIG. 27 is a diagram for illustrating the transmission of the CCM frames, and FIG. 28 is a diagram showing exemplary information that may be acquired after performing the CC function in the third example in the second embodiment.

Thus, the communication apparatus A 10 can acquire the network information shown in FIG. 24 with the LB function, LT function, and CC function. The communication apparatus A 10 can also perform monitoring and performance measurement periodically by using a cycle determined from the CC transmission interval (Period) or a cycle arbitrarily set by a user.

### Fourth Example

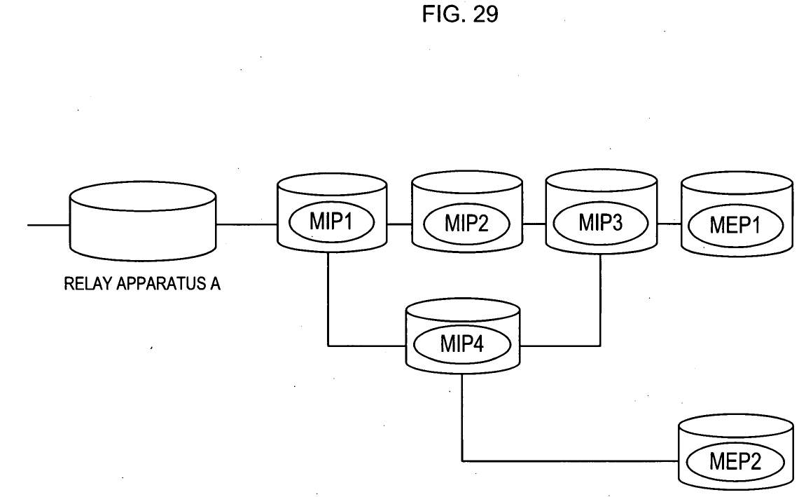

Now, a fourth example will be described with reference to FIGS. 29 to 35. FIG. 29 is a diagram of a network in the fourth example collected in the second embodiment. In the fourth example, an example of collecting network information shown in FIG. 29 will be described.

In this network, the LB function unit 32 of the communication apparatus A 10 transmits an LBM frame to the network by using the multicast LB function of the Ethernet-OAM protocol. Since only MEPs are to respond to this LBM frame, the EO frame identification unit 11 of the communication apparatus A receives LBR frames transmitted from an MEP1 and an MEP2 respectively.

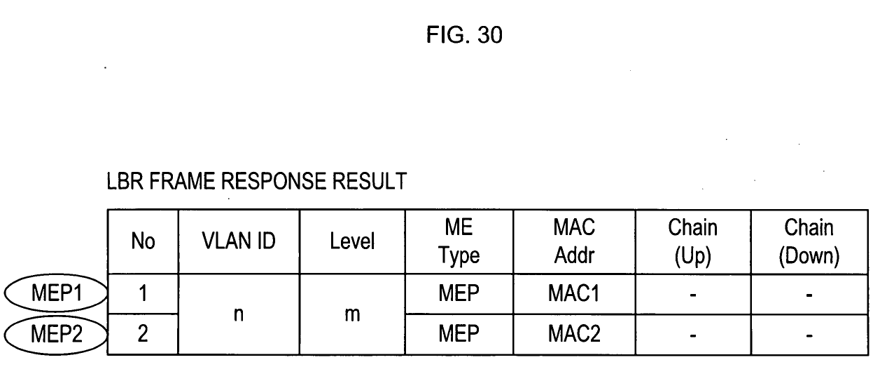

The MEP information acquisition unit 41 of the communication apparatus A recognizes the existence of the MEP1 and the MEP2 in the network shown in FIG. 29, and acquires “VLANID=n, Level=m, MAC address=MAC1, MAC2” as the MEP information from the respective received LBR frames and stores them in the topology detection result DB 15 (see FIG. 30). FIG. 30 is a diagram showing exemplary information that may be acquired after performing the LB function in the fourth example in the second embodiment.

The LT function unit 33 of the communication apparatus A then transmits an LTM frame using the multicast LT function of the Ethernet-OAM protocol to the MEPs identified by the MEP information acquisition unit 41. Since MEPs and MIPs are to respond to this LTM frame, the EO frame identification unit 11 of the communication apparatus A receives LTR frames transmitted from the MEP1, the MEP2, and MIPs, respectively.

When the LTR frames are received as responses to the LTM frame transmitted from the LT function unit 33, the MIP information acquisition unit 42 of the communication apparatus A identifies communication apparatuses as MIPs from the LTR frames and acquires the MIP information indicating information about the MIPs.

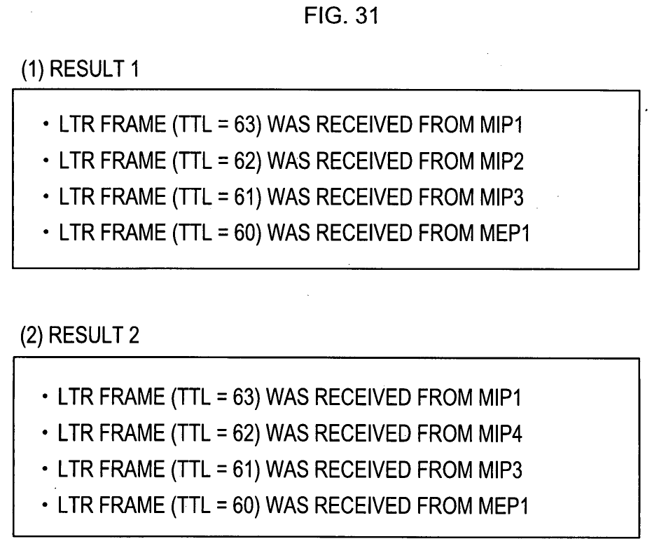

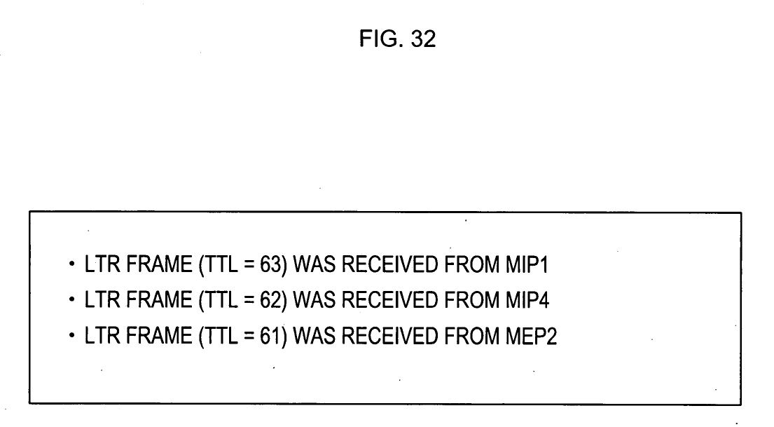

Specifically, since all MEPs/MIPs are to respond, when the LTM frame (TTL=64) is transmitted to the MEP1 by the LT function unit 33, the MIP information acquisition unit 42 obtains response results “result 1” and “result 2” as shown in FIG. 31. Also, when the LTM frame (TTL=64) is transmitted to the MEP2 by the LT function unit 33, a response result shown in FIG. 32 is obtained. FIG. 31 is a diagram showing the LTM response results for the MEP1 in the fourth example in the second embodiment, and FIG. 32 is a diagram showing the LTM response result for the MEP2 in the fourth example in the second embodiment.

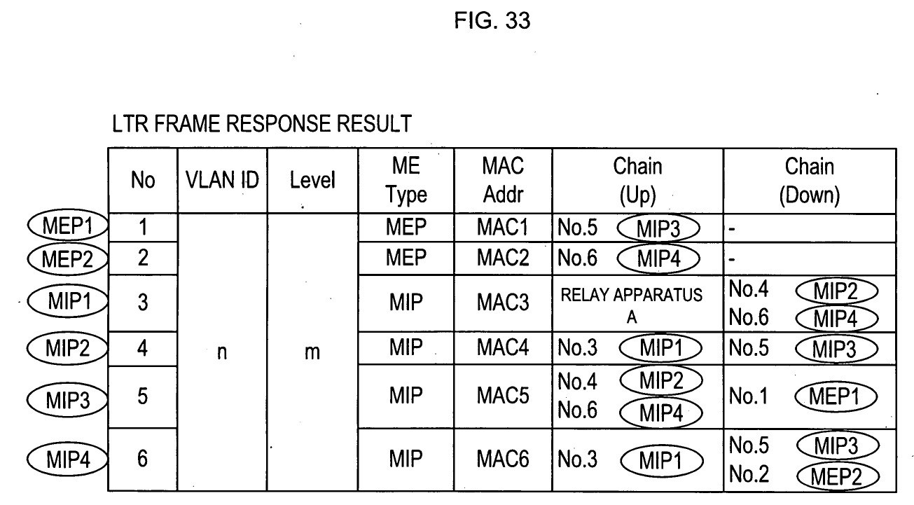

Here, by using the same approach as the above-described first example to check the TTL differences, the MIP information acquisition unit 42 recognizes the existence of the MIP1, MIP2, MIP3, and MIP4 in the network shown in FIG. 29, and acquires the position relationships between each apparatus and the MIP information and stores them in the topology detection result DB 15 (see FIG. 33). Similarly, for the MEPs, the MEP information acquisition unit 41 acquires an upstream apparatus and a downstream apparatus for each of the MEP1 and MEP2 and stores them in the topology detection result DB 15. FIG. 33 is a diagram showing exemplary information that may be acquired after performing the LT function in the fourth example in the second embodiment.

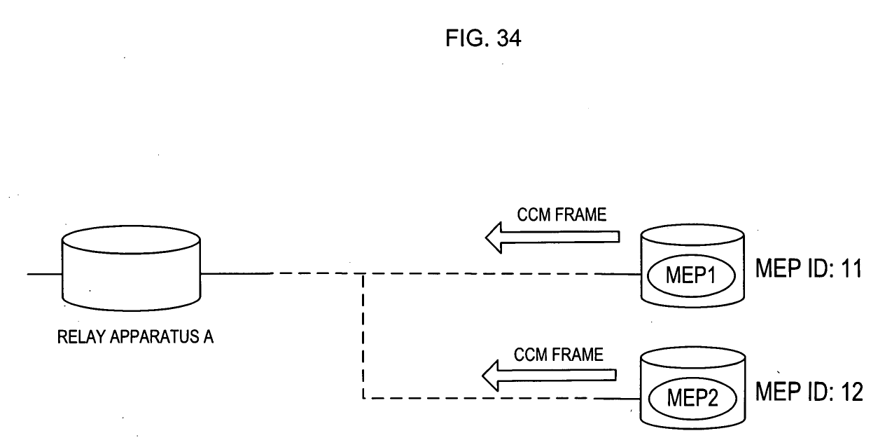

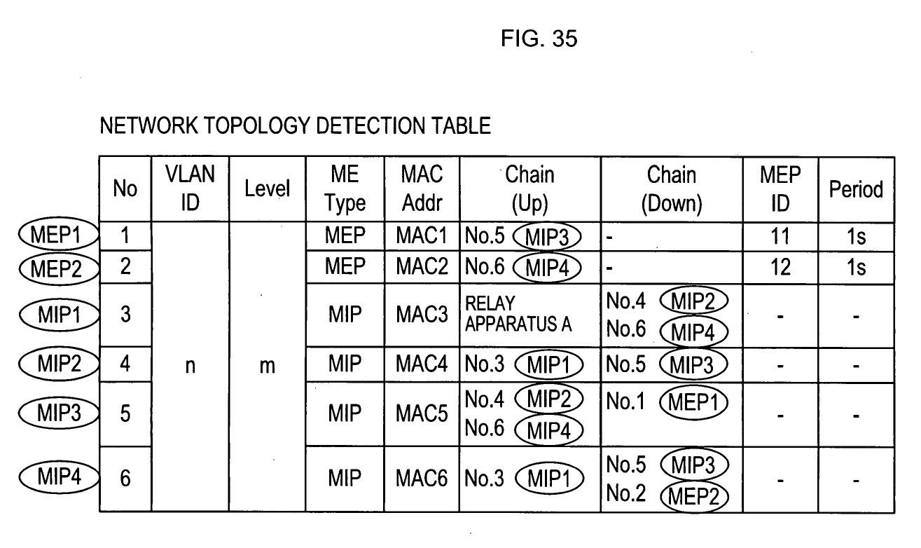

The communication apparatus A 10 then waits for reception of CCM frames. Thereafter, as shown in FIG. 34, the MEP1 and the MEP2 periodically transmit a CCM frame to the network, and the EO frame identification unit 11 of the communication apparatus A 10 receives the CCM frames. Therefore, the topology detection processing sequencer 43 detects MEPID and Period of the MEP1 and the MEP2 and stores them in the topology detection result DB 15 (see FIG. 35). FIG. 34 is a diagram for illustrating the transmission of the CCM frames, and FIG. 35 is a diagram showing exemplary information that may be acquired after performing the CC function in the fourth example in the second embodiment.

Thus, the communication apparatus A 10 can acquire the network information shown in FIG. 29 with the LB function, LT function, and CC function. The communication apparatus A 10 can also perform monitoring and performance measurement periodically by using a cycle determined from the CC transmission interval (Period) or a cycle arbitrarily set by a user.

### Advantages of Second Embodiment

Thus, according to the second embodiment, the network connection relationships can be automatically acquired for various networks.

### Third Embodiment

The present invention may be implemented in various different forms besides the above-described embodiments. Different embodiments will be described for each of the (1) system and (2) program.

(1) System

The elements of each apparatus shown in the figures are conceptual with respect to their function and not necessarily have to be physically the same as in the figures. That is, the specific form of distribution and integration of the apparatuses is not limited to the form shown in the figures, and all or some of them may be functionally or physically distributed or integrated in any unit depending on various loads and usage situations. Further, all or any part of processing functions performed in each apparatus may be implemented by a CPU and a program interpreted and executed by the CPU, or may be implemented as wired logic based hardware.

In the processing described in the embodiments, all or some of the processes described as being performed automatically may be performed manually, or all or some of the processes described as being performed manually may be performed automatically in a known manner. In addition, processing operations, control operations, specific names, and information including various data and parameters stated in the above description or in the diagrams may be arbitrarily modified unless otherwise specified.

(2) Program

The various kinds of processes described in the above embodiments may be implemented by executing a prepared program in a computer system such as a personal computer or workstation. In the following description, a computer system that executes a program having the same functions as in the above embodiments will be described as another embodiment.

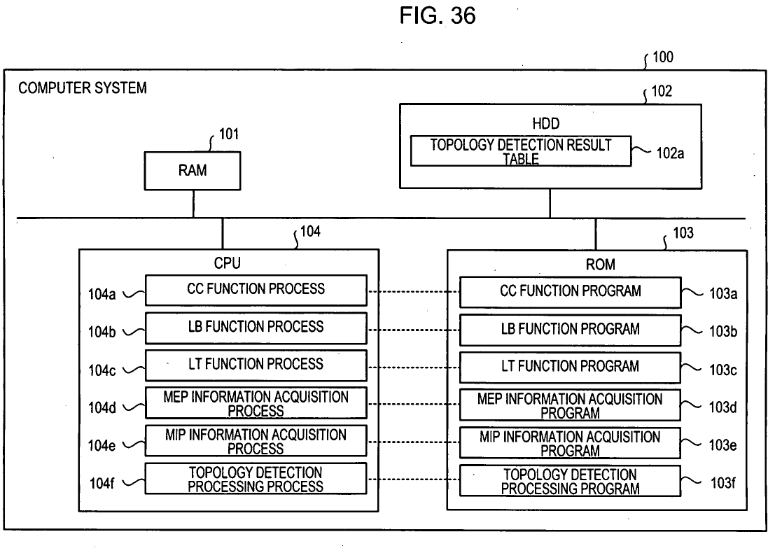

FIG. 36 is a diagram showing an exemplary computer system that executes a network information collecting program. As shown in FIG. 36, the computer system 100 has a RAM 101, an HDD 102, a ROM 103, and a CPU 104. The ROM 103 stores in advance a program that exerts the same functions as in the above embodiments, that is, a CC function program 103a, an LB function program 103b, an LT function program 103c, an MEP information acquisition program 103d, an MIP information acquisition program 103e, and a topology detection processing program 103f as shown in FIG. 36.

These programs 103a to 103f are read out and executed by the CPU 104, so that they become a CC function process 104a, an LB function process 104b, an LT function process 104c, an MEP information acquisition process 104d, an MIP information acquisition process 104e, and a topology detection processing process 104f as shown in FIG. 36. The CC function process 104a corresponds to the CC function unit 31 shown in FIG. 2. Similarly, the LB function process 104b corresponds to the LB function unit 32, the LT function process 104c corresponds to the LT function unit 33, the MEP information acquisition process 104d corresponds to the MEP information acquisition unit 41, the MIP information acquisition process 104e corresponds to the MIP information acquisition unit 42, and the topology detection processing process 104f corresponds to the topology detection processing sequencer.

The HDD 102 is provided with a topology detection result table 102a that stores the generated topology information and various kinds of acquired information. The topology detection result table 102a corresponds to the topology detection result DB 15 shown in FIG. 2.

The above programs 103a to 103f are not necessarily have to be stored in the ROM 103 but may be stored in, for example, “portable physical media” such as a flexible disk (FD), CD-ROM, MO disk, DVD disk, magneto-optical disk, and IC card inserted into the computer system 100, as well as “nonremovable physical media” such as a hard disk drive (HDD) internally or externally provided in the computer system 100, or even “other computer systems” connected to the computer system 100 via a public line, the Internet, a LAN, or a WAN, so that the computer system 100 may read out the programs from these media or systems and execute the programs.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A communication apparatus communicatively interconnected to a plurality of communication apparatuses, comprising:
an LBM frame transmission unit that transmits an LBM frame to a network by using a multicast LB function of a maintenance protocol;
an MEP information acquisition unit that identifies a communication apparatus having transmitted an LBR frame as an MEP when the LBR frame is received as a response to the LBM frame transmitted by the LBM frame transmission unit, and acquires MEP information indicating information about the MEP from the LBR frame;
an LTM frame transmission unit that transmits an LTM frame using a multicast LT function of the maintenance protocol to the MEP identified by the MEP information acquisition unit;
an MIP information acquisition unit that identifies a communication apparatus as an MIP from an LTR frame when the LTR frame is received as a response to the LTM frame transmitted by the LTM frame transmission unit, and acquires MIP information indicating information about the MIP; and
a topology information generation unit that generates topology information representing a configuration of the network from the MEP information acquired by the MEP information acquisition unit and the MIP information acquired by the MIP information acquisition unit.

2. The communication apparatus according to claim 1, further comprising a CC information extraction unit that receives a CCM frame transmitted by using a multicast CC function of the maintenance protocol from the communication apparatus identified as the MEP by the MEP information acquisition unit, and extracts an MEPID and a CC periodical transmission interval from the CCM frame.

3. The communication apparatus according to claim 1, wherein the topology information generation unit displays the generated topology information on a predetermined display unit.

4. The communication apparatus according to claim 1, wherein
the LBM frame transmission unit transmits the LBM frame to the network at predetermined intervals by using the multicast LB function of the maintenance protocol, and
the LTM frame transmission unit transmits the LTM frame using the multicast LT function of the maintenance protocol to the MEP identified by the MEP information acquisition unit.

5. A recording medium having recorded thereon a network information collecting program executed by a computer as a communication apparatus communicatively interconnected to a plurality of communication apparatuses, comprising:
an LBM frame transmission process for transmitting an LBM frame to a network by using a multicast LB function of a maintenance protocol;
an MEP information acquisition process for identifying a communication apparatus having transmitted an LBR frame as an MEP when the LBR frame is received as a response to the LBM frame transmitted by the LBM frame transmission process, and acquiring MEP information indicating information about the MEP from the LBR frame;
an LTM frame transmission process for transmitting an LTM frame using a multicast LT function of the maintenance protocol to the MEP identified by the MEP information acquisition process;
an MIP information acquisition process for identifying a communication apparatus as an MIP from an LTR frame when the LTR frame is received as a response to the LTM frame transmitted by the LTM frame transmission process, and acquiring MIP information indicating information about the MIP; and
a topology information generation process for generating topology information representing a configuration of the network from the MEP information acquired by the MEP information acquisition process and the MIP information acquired by the MIP information acquisition process.

6. A network information collecting method suitable for a communication apparatus communicatively interconnected to a plurality of communication apparatuses in compliance with a maintenance protocol, comprising:
transmitting an LBM frame to a network by using a multicast LB function of the maintenance protocol;
identifying a communication apparatus having transmitted an LBR frame as an MEP when the LBR frame is received as a response to the LBM frame transmitted in the LBM frame transmission, and acquiring MEP information indicating information about the MEP from the LBR frame;
transmitting an LTM frame using a multicast LT function of the maintenance protocol to the MEP identified in the MEP information;
identifying a communication apparatus as an MIP from an LTR frame when the LTR frame is received as a response to the LTM frame transmitted in the LTM frame transmission, and acquiring MIP information indicating information about the MIP; and
generating topology information representing a configuration of the network from the MEP information and the MIP information.

7. The communication apparatus according to claim 2, wherein the topology information generation unit displays the generated topology information on a predetermined display unit.

8. The communication apparatus according to claim 2, wherein
the LBM frame transmission unit transmits the LBM frame to the network at predetermined intervals by using the multicast LB function of the maintenance protocol, and
the LTM frame transmission unit transmits the LTM frame using the multicast LT function of the maintenance protocol to the MEP identified by the MEP information acquisition unit.

9. The communication apparatus according to claim 3, wherein
the LBM frame transmission unit transmits the LBM frame to the network at predetermined intervals by using the multicast LB function of the maintenance protocol, and
the LTM frame transmission unit transmits the LTM frame using the multicast LT function of the maintenance protocol to the MEP identified by the MEP information acquisition unit.
